(19) United States
(12) Patent Application Publication
(10) Pub. No.: US 2008/0143892 A1
(43) Pub. Date: Jun. 19, 2008

(54) Mobile control system

(75) Inventor: Gordon Jay Lytell, Ashburn, VA (US)

Correspondence Address: BREINER & BREINER, L.L.C., P.O. BOX 320160, ALEXANDRIA, VA, 22320-0160, US

(73) Assignee: VuStar, LLC, Falls Church, VA (US)

(21) Appl. No.: 11/639,277

(22) Filed: Dec. 15, 2006

(51) Int. Cl. H04N 5/64

(52) U.S. Cl. 348/837

(57) ABSTRACT

A passenger-oriented mobile control system which governs multiple audio, video, vehicle, communications and entertainment components through a single graphical interface in a mobile vehicle environment is disclosed. The system provides multiple satellite radio channels, satellite television, a GPS system, DVD entertainment, the ability to upload various types of flash media/presentations for viewing or modifying its content, and the like. The system enables passengers of a mobile vehicle to control, view and/or listen to each chosen audio and/or visual output either collectively and/or individually. The system also provides assistance and direction to at least a driver such as by displaying faults or errors that occur in the normal operation of the vehicle. The system can also provide direct telephonic, video, GPS, and satellite on board support to the vehicle drivers and passengers. The system includes cabin based components and an assembly enclosure having various audio and/or video controlling components.

### FIELD OF INVENTION

The present invention relates to a passenger-oriented mobile control system that governs multiple audio, video, vehicle, communications and entertainment components through a single graphical interface in a mobile vehicle environment. The mobile control system provides multiple satellite radio channels, satellite television, a global positioning system, DVD entertainment, the ability to upload various types of flash media/presentations for viewing or modifying its content, and the like. The mobile control system enables passengers of a mobile vehicle to control, view and/or listen to each chosen audio or visual output either collectively and/or individually. The mobile control system also provides assistance and direction to at least a driver such as by displaying faults or errors that occur in the normal operation of the vehicle. The mobile control system includes cabin based components and an assembly enclosure having various audio and/or video type controlling components.

### BACKGROUND OF INVENTION

In today's busy world, people need or want to have access to audio, video, communications, and entertainment media or capabilities at any determined time of a day. However, people often have difficulties with this during traveling, especially while traveling on mass transportation vehicles such as buses, airplanes and ships. In order to have access to radio, television, satellite, global positioning system data, entertainment data, business, flash media presentations, and/or the like, mass transportation vehicles need to be linked to these outside sources, but vehicles are not equipped to provide this in a convenient and efficient manner. This and other shortcomings of mass transportation vehicles are addressed by the present invention.

### OBJECTS AND SUMMARY OF INVENTION

The present invention relates to a passenger-oriented mobile control system that governs multiple audio, video, vehicle, communications and entertainment components through a single graphical interface in a mobile vehicle environment. The mobile control system provides multiple satellite radio channels, satellite television, a global positioning system (GPS), DVD entertainment, the ability to upload various types of flash media/presentations for viewing or modifying its content, and the like. The mobile control system enables passengers of a mobile vehicle to control, view and/or listen to each chosen or predetermined audio and/or visual output either collectively and/or individually. The mobile control system also provides assistance and direction to at least a driver such as by displaying faults or errors that occur in the vehicle during operation thereof. The mobile control system may also be able to provide direct telephonic, video, GPS, and satellite on board support to the vehicle driver and passengers.

The mobile control system comprises cabin based components and an assembly enclosure having various audio and/or video type controlling components. The cabin based components include a combination of seat driven selection devices, viewing monitors, speakers, at least one amplifier, various antennas, touch panel screens for controlling the system, at least one subwoofer, a DVD player, at least one microphone, a flash card reader, a multichannel audio system (MAS) unit, an electronic control unit (ECU), a control processor, and the like. The assembly enclosure includes components of the system that enable video and/or audio switching, controlling, and/or presenting, satellite receivers, a computer, a GPS receiver and the like.

Each component of the mobile control system connects to at least one other component of the mobile control system by a suitable connection member, such as a cable. More particularly, each cabin based component connects directly or indirectly to the assembly enclosure, i.e., at least one component therein, by a suitable connection member, such as a cable. Each component of the assembly enclosure connects to at least one cabin based component, at least one other component in the assembly enclosure and/or a predetermined object by a suitable connection member, such as a cable. While the connection members are described in terms of cables hereafter, any suitable connection member may be used including, but not limited to, wireless connection members, radio frequency (RF) connections, fiber optic connections, Bluetooth® connections, infrared receiver connections, RCA component connections and any combination thereof.

A primary object of the present invention is to provide a passenger-oriented mobile control system that governs multiple audio, video, vehicle, communications and entertainment components through a graphical user interface (GUI) in a mobile vehicle environment.

Another primary object of the present invention is to provide a mobile control system which provides multiple satellite radio channels, satellite television, a GPS system, DVD entertainment, the ability to upload various types of flash media/presentations for viewing or modifying its content and the like to passengers of a vehicle.

Another primary object of the present invention is to provide a mobile control system for a mass transportation vehicle which enables multiple passengers to control, view and/or listen to chosen audio and/or visual output either collectively or individually.

Another primary object of the present invention is to provide a mobile control system which provides assistance and direction to at least a driver such as by displaying faults or errors that occur in the vehicle during operation thereof.

These primary and other objects of the invention will be apparent from the following description of the preferred embodiments of the invention and from the accompanying drawings.

### BRIEF DESCRIPTION OF THE DRAWINGS

Referring to the drawings:

FIG. 1 illustrates an overall schematic layout of a first embodiment of a mobile control system of the present invention.

FIG. 2 illustrates an overall schematic layout of a second embodiment of a mobile control system of the present invention.

FIG. 3 illustrates an exploded perspective view of a first embodiment of an assembly enclosure of the mobile control system.

FIG. 4 illustrates an exploded front view of the assembly enclosure of FIG. 3.

FIG. 5A illustrates a front view of a second embodiment of an assembly enclosure of the mobile control system.

FIG. 5B illustrates a side view of the assembly enclosure of FIG. 5A.

FIG. 6 illustrates an exploded view of an assembly chassis of the assembly enclosure of the mobile control system.

FIG. 7 illustrates a side view of the assembly chassis of FIG. 6.

FIG. 8 illustrates a partial detail view of a side wall panel of the assembly chassis of FIG. 7 along line 7-7.

FIG. 9 illustrates a perspective view of a mounting plate for an extended module (XM) receiver in the assembly enclosure of the mobile control system of the present invention.

FIG. 10 illustrates perspective view of a mounting plate for a matrix switcher in the assembly enclosure of the mobile control system of the present invention.

FIG. 11 illustrates a perspective view of a mounting plate for a mixer in the assembly enclosure of the mobile control system of the present invention.

FIG. 12 illustrates a perspective view of a mounting plate for a universal presentation processor in the assembly enclosure of the mobile control system of the present invention.

FIG. 13 illustrates a perspective view of a mounting plate for a scaler in the assembly enclosure of the mobile control system of the present invention.

FIG. 14 illustrates a perspective view of a mounting plate for a satellite receiver in the assembly enclosure of the mobile control system of the present invention.

FIG. 15 illustrates a perspective view of a mounting plate for a video sync sensor module in the assembly enclosure of the mobile control system of the present invention.

FIG. 16 illustrates a perspective view of a mounting plate for a computer in the assembly enclosure of the mobile control system of the present invention.

FIG. 17 illustrates a side perspective view of a mounting bracket for a power strip in the assembly enclosure of the mobile control system of the present invention.

FIG. 18 illustrates a bottom perspective view of the mounting bracket of FIG. 17.

FIG. 19 illustrates a back view of a monitor of the mobile control system of the present invention.

FIG. 20 illustrates a bottom view of the monitor of FIG. 19.

FIG. 21 illustrates an end view of a cable port of a monitor of the mobile control system of the present invention.

FIG. 22 illustrates a top view of a cable pin connector of the present invention.

FIG. 23 illustrates an end view of a cable pin connector of a monitor of the mobile control system of the present invention.

FIG. 24 illustrates the cable pin connector of FIG. 23 showing color designation of the pins.

FIG. 25 illustrates a top view of a cable connector of the mobile control system of the present invention.

FIG. 26A illustrates a partial view of a back of a touch panel of the mobile control system of the present invention showing various ports of the touch panel.

FIG. 26B illustrates a partial view of a back of a touch panel of the mobile control system of the present invention showing various ports of the touch panel.

FIG. 27 illustrates a red/green/blue (RGB) video in cable port of FIG. 26A.

FIG. 28 illustrates a RGB video out cable port of FIG. 26A.

FIG. 29 illustrates a cable connector which connects a monitor to the assembly enclosure of the mobile control system of the present invention.

FIG. 30 illustrates a universal serial bus (USB) cable connection between a universal presentation processor and the touch panel of FIG. 26B.

FIG. 31 illustrates a rear view of second embodiment of a touch panel of the mobile control system of the present invention.

FIG. 32 illustrates a net connector of the touch panel of FIG. 31.

FIGS. 33 and 34 illustrate a NTSC/PAL video input connector of the touch panel of FIG. 31.

FIG. 35 illustrates an exploded view of a cable connection between a universal presentation processor and a flash card reader of the mobile control system of the present invention.

FIG. 36 illustrates a partial view of a subwoofer amplifier of the mobile control system of the present invention showing various ports of the subwoofer amplifier.

FIG. 37 illustrates an audio in port of the subwoofer amplifier of FIG. 36.

FIG. 38 illustrates a control port of the subwoofer amplifier of FIG. 36.

FIG. 39 illustrates a speaker port of the subwoofer amplifier of FIG. 36.

FIG. 40 illustrates a power in connector of the subwoofer amplifier of FIG. 36.

FIG. 41 illustrates an embodiment of a DVD power cable of the mobile control system of the present invention.

FIG. 42 illustrates a side view of the DVD power cable connector of FIG. 41.

FIG. 43 illustrates an end view of the DVD power cable connector of FIG. 41.

FIG. 44 illustrates an embodiment of a GPS receiver of the mobile control system of the present invention.

FIG. 45 illustrates a side view of a power connector of the GPS receiver of FIG. 44.

FIG. 46 illustrates a front view of a data P1 connector of the GPS receiver of FIG. 44.

FIG. 47 illustrates an embodiment of a mixer of the mobile control system of the present invention.

FIG. 48 illustrates a MIC 1 jumper setting of the mixer of FIG. 47.

FIG. 49 illustrates a MIC 2 jumper setting of the mixer of FIG. 47.

FIG. 50 illustrates a phoenix connector of the mixer of FIG. 47.

FIG. 51 illustrates an embodiment of a bus control system of the mobile control system of the present invention.

FIG. 52 illustrates a front view of a matrix switcher of the mobile control system of the present invention.

FIG. 53 illustrates a back view of the matrix switcher of FIG. 52.

FIG. 54 illustrates a front view of a first embodiment of an amplifier of the mobile control system of the present invention.

FIG. 55 illustrates a back view of the amplifier of FIG. 54.

FIG. 56 illustrates a cable connection between the amplifier of FIG. 55 and a mixer of the mobile control system of the present invention.

FIG. 57 illustrates a front view of a second embodiment of an amplifier of the mobile control system of the present invention.

FIG. 58 illustrates a back view of the amplifier of FIG. 57.

FIG. 59 illustrates a front view of a video scaler (SAT TV) of the mobile control system of the present invention.

FIG. 60 illustrates a back view of the video scaler (SAT TV) of FIG. 59.

FIG. 61 illustrates a front view of a video scaler (DVD) of the mobile control system of the present invention.

FIG. 62 illustrates a back view of the video scaler (DVD) of FIG. 61.

FIG. 63 illustrates an embodiment of a television satellite receiver of the mobile control system of the present invention.

FIG. 64 illustrates an embodiment of a satellite antenna in-door unit (IDU) of the mobile control system of the present invention.

FIG. 65 illustrates a front view of an embodiment of an on board computer of the mobile control system of the present invention.

FIG. 66 illustrates a back view of the on board computer of FIG. 65.

FIG. 67 illustrates a front view of an embodiment of a video sync sensor module of the mobile control system of the present invention.

FIG. 68 illustrates a partial view of an embodiment of a converter of the mobile control system of the present invention.

FIG. 69 illustrates an embodiment of a first XM receiver of the mobile control system of the present invention.

FIG. 70 illustrates an embodiment of a second XM receiver of the mobile control system of the present invention.

FIG. 71 illustrates a back view of an embodiment of a universal presentation processor of the mobile control system of the present invention.

FIG. 72 illustrates a top panel of a network terminal block (CNT block) of the mobile control system of the present invention.

FIG. 73 illustrates a side panel of the network terminal block of FIG. 72.

FIG. 74 illustrates a net connector of the top panel of the network terminal block of FIG. 72.

FIG. 75 illustrates a back view of an embodiment of a DVD player of the mobile control system of the present invention.

FIG. 76 illustrates an embodiment of a splitter of the mobile control system of the present invention.

FIG. 77 illustrates a side view of a GPS antenna of the mobile control system of the present invention.

FIG. 78 illustrates a top view of the GPS antenna of FIG. 77.

FIG. 79 illustrates a bottom view of the GPS antenna of FIG. 77.

FIG. 80 illustrates a bottom view of a hex head mounting screw of the GPS antenna of FIG. 77.

FIG. 81 illustrates a side view of the hex head mounting screw (with a plate) of FIG. 80.

FIG. 82 illustrates a first embodiment of a driver assistance and direction system of the mobile control system of the present invention;

FIG. 83 illustrates a second embodiment of a driver assistance and direction system of the mobile control system of the present invention.

FIG. 84 illustrates a front view of a power inverter of the mobile control system of the present invention.

FIG. 85 illustrates a back view of the power inverter of FIG. 84.

### DETAILED DESCRIPTION OF THE PREFERRED EMBODIMENTS

The passenger-oriented mobile control system 100 governs multiple audio, video, vehicle, communications and entertainment components through a single graphical user interface in a mobile vehicle environment. The mobile control system 100 provides multiple satellite radio channels, satellite television, a global positioning system, DVD entertainment, the ability to upload various types of flash media/presentations for viewing or modifying its content, and the like. The mobile control system 100 enables passengers of a mobile vehicle to control, view and/or listen to each chosen or predetermined audio and/or visual output either collectively and/or individually. The mobile control system 100 also provides assistance and direction to at least a driver such as by displaying faults or errors that occur in the vehicle during operation. The mobile control system 100 can also provide direct telephonic, video, GPS, and satellite on board support to the vehicle driver and passengers.

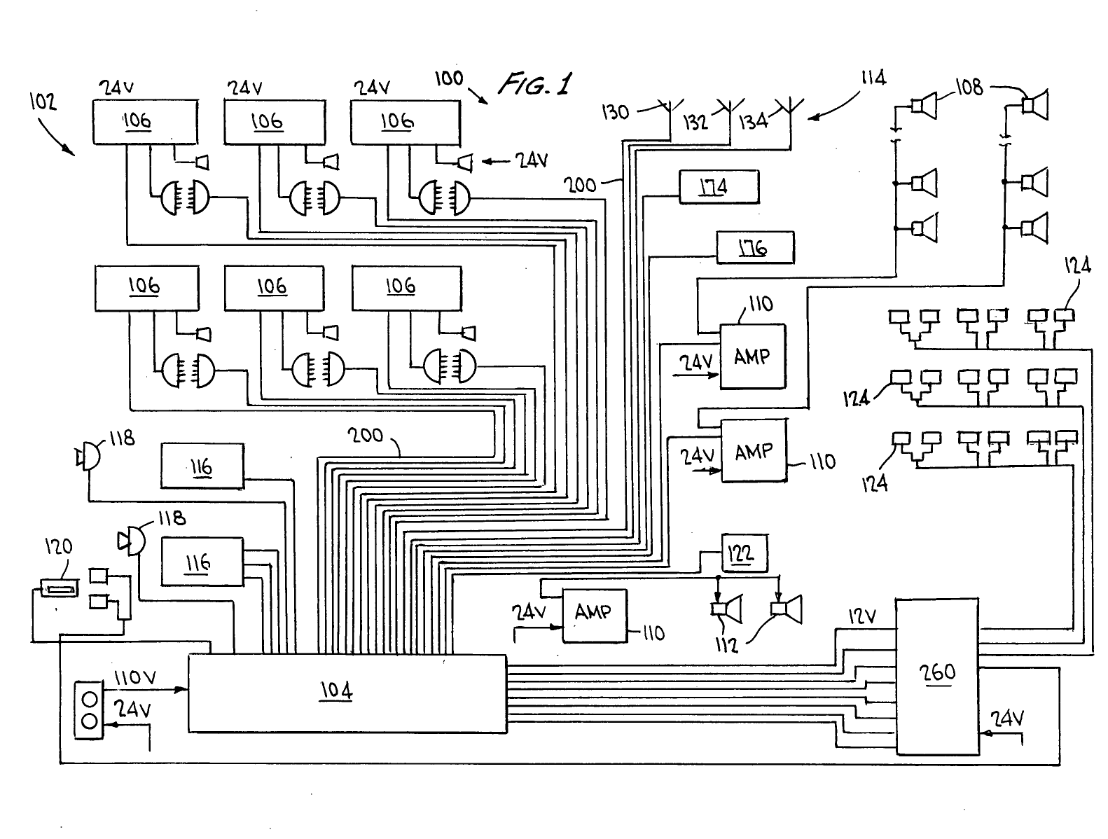

Referring to FIGS. 1-85, the mobile control system 100 comprises cabin based components 102 and an assembly enclosure 104 having various audio and/or video type controlling components. The cabin based components 102 include a combination of seat driven selection devices such as passenger modules 124, viewing monitors 106, speakers 108, at least one amplifier 110, at least one subwoofer 112, various antennas 114, touch panels 116 for controlling the system, at least one microphone 118, a DVD player 120, a flash card reader 122, a multichannel audio system (MAS) unit 260, an electronic control unit (ECU) 174, a control processor 176 and the like. The assembly enclosure 104 includes components that enable video and/or audio switching, controlling, and/or presenting, satellite receivers, a computer, a GPS receiver and the like.

Each component of the mobile control system 100 is connected to at least one other component of the mobile control system 100 by a suitable connection member 200, such as a cable. Each cabin based component 102 is connected, either directly or indirectly, to the assembly enclosure by a suitable connection member 200, such as a cable. More particularly, each cabin based component 102 is connected, either directly or indirectly, to at least one component in the assembly enclosure 104. Each component in the assembly enclosure 104 is connected to at least one cabin based component 102, at least one other component in the assembly enclosure 104 and/or a predetermined object by a suitable connection member 200, such as a cable. While the connection members are described in terms of cables hereafter, any suitable connection member may be used including, but not limited to, wireless connection members, radio frequency connections, fiber optic connections, RCA component connections, Bluetooth® connections, infrared receiver connections and any combination thereof.

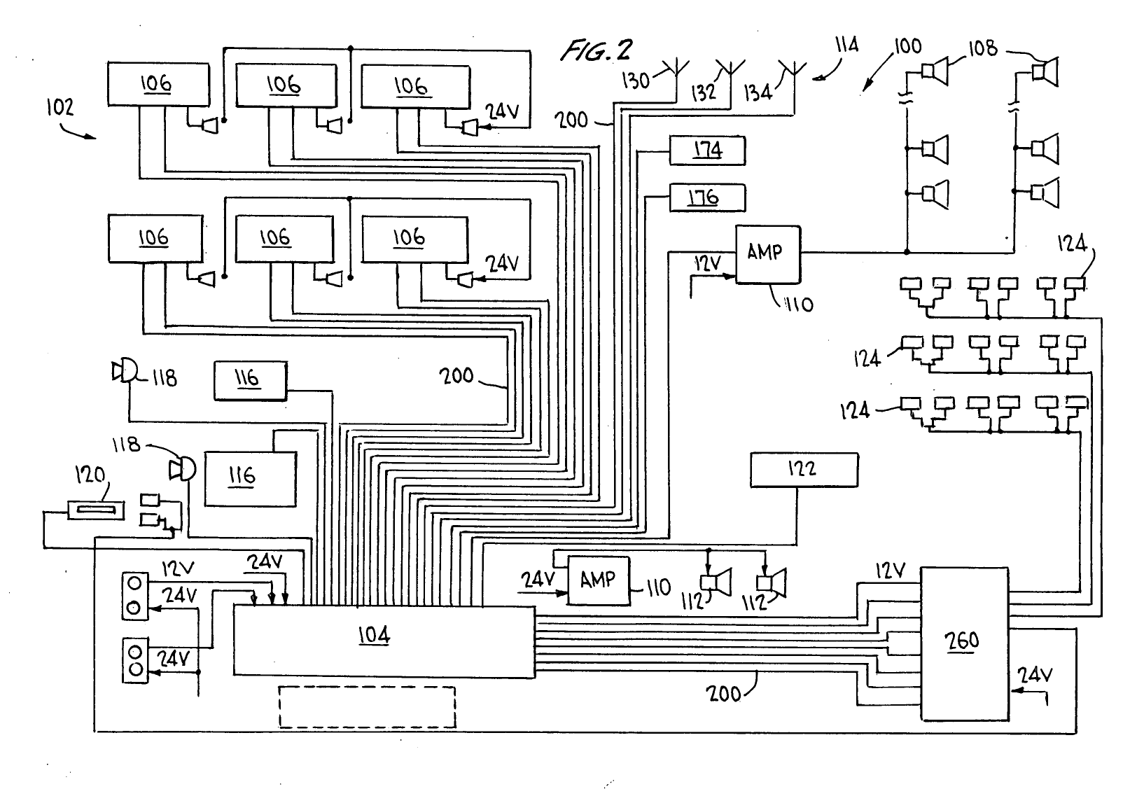

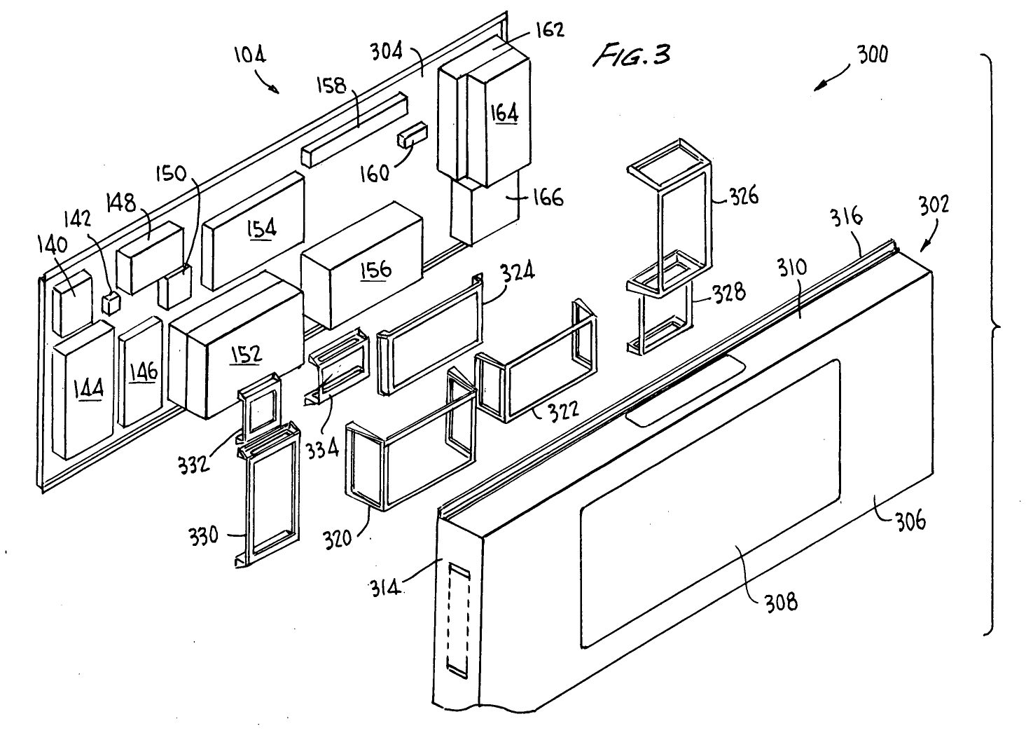

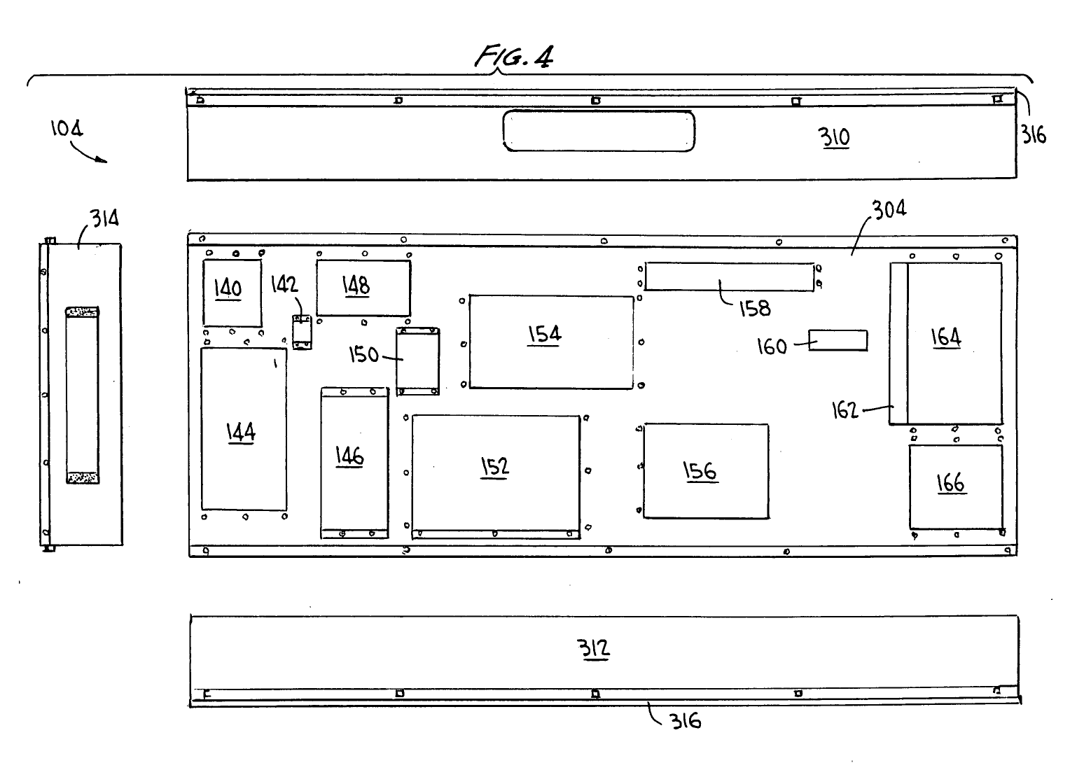

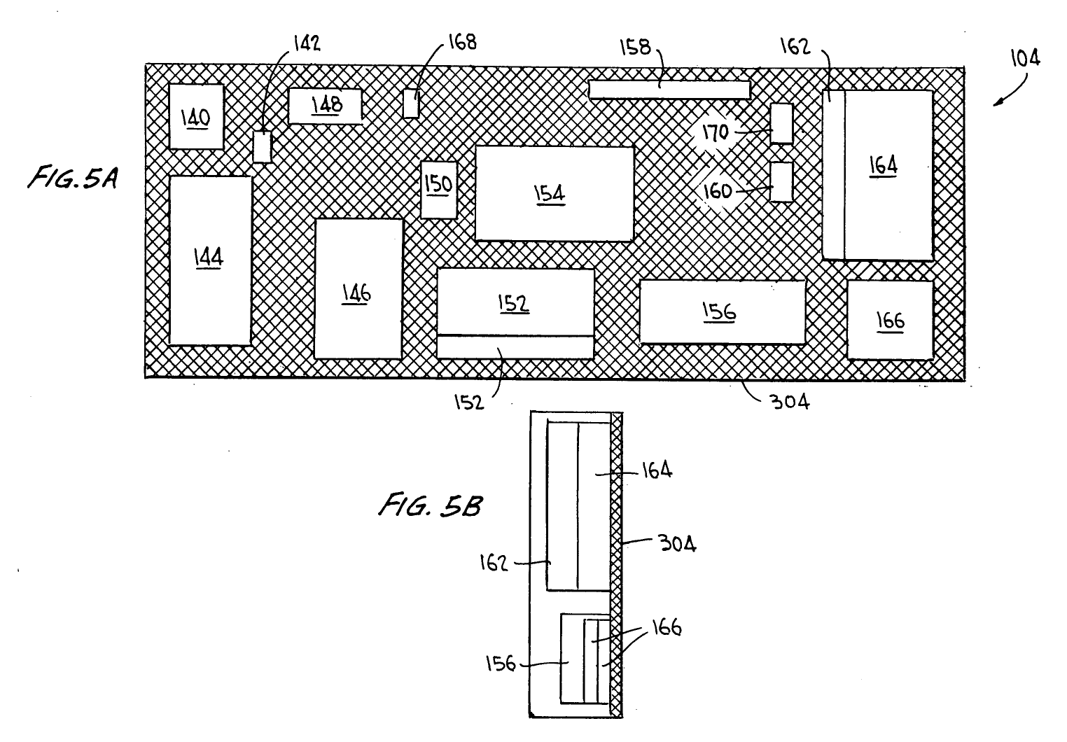

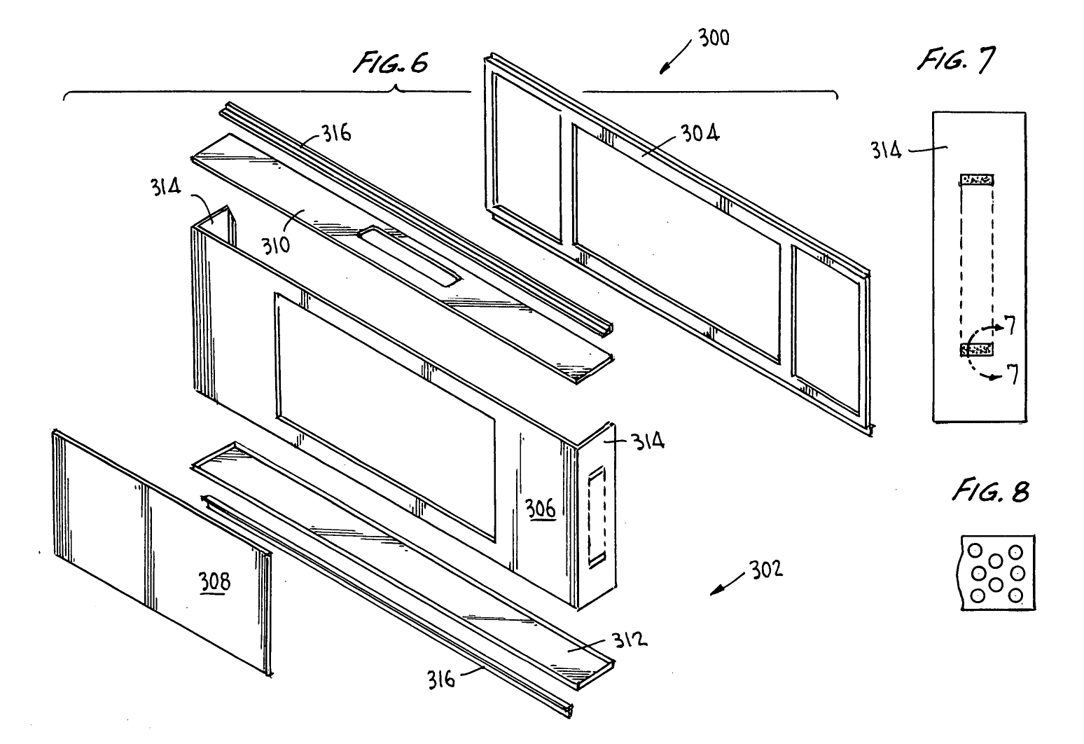

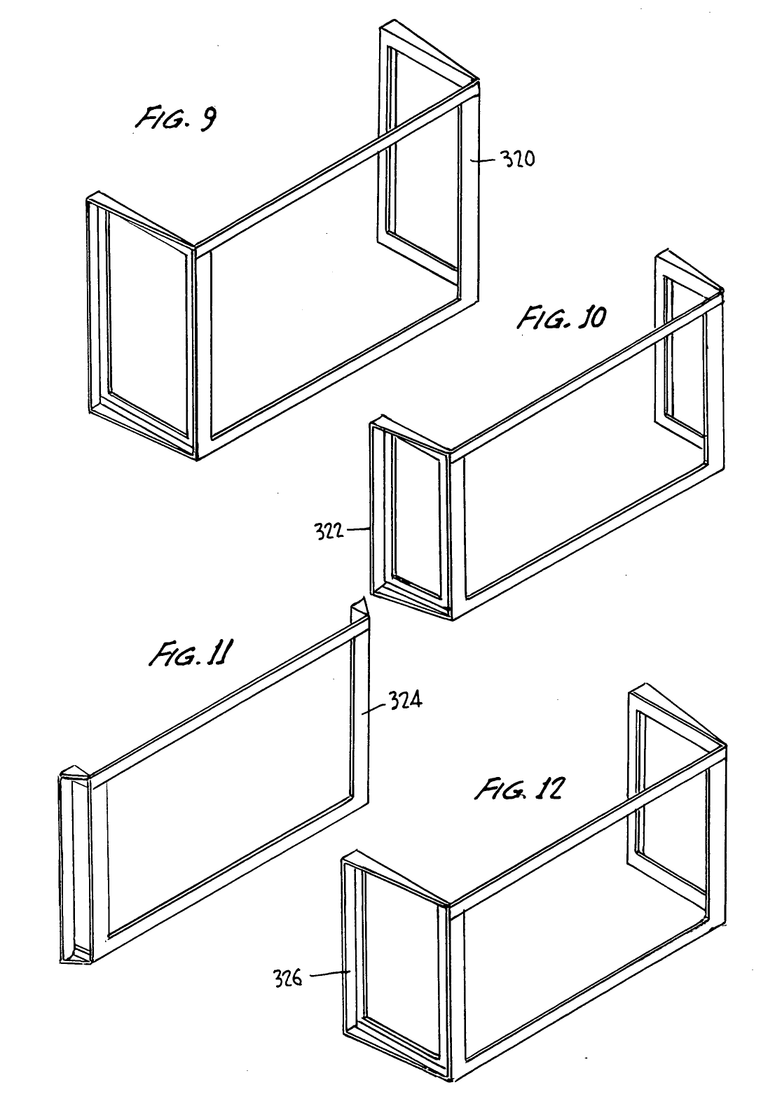

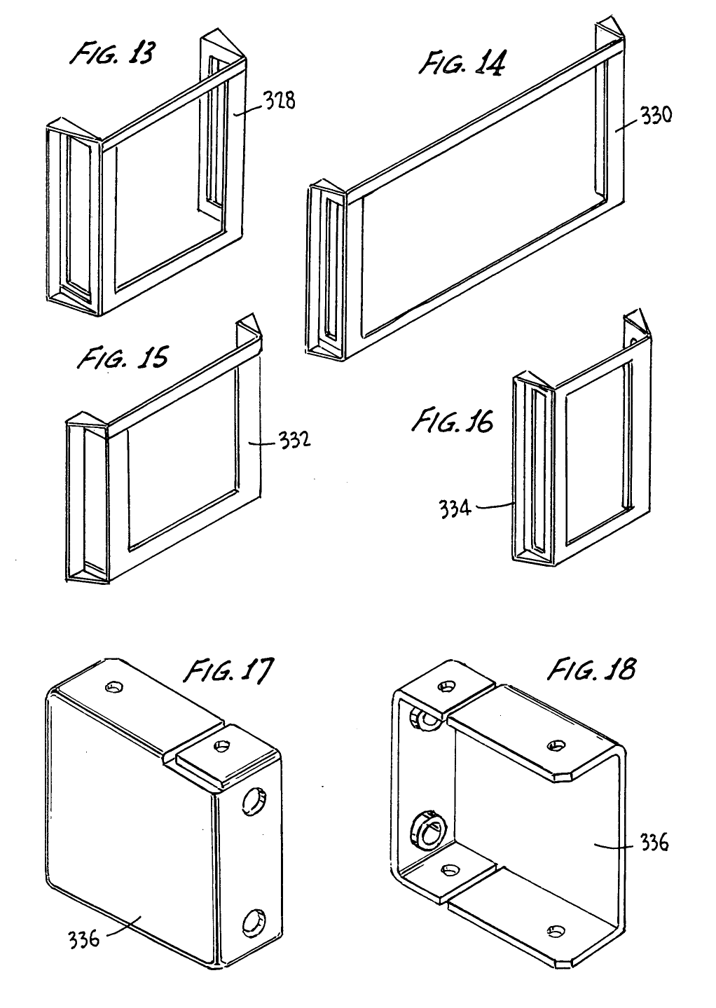

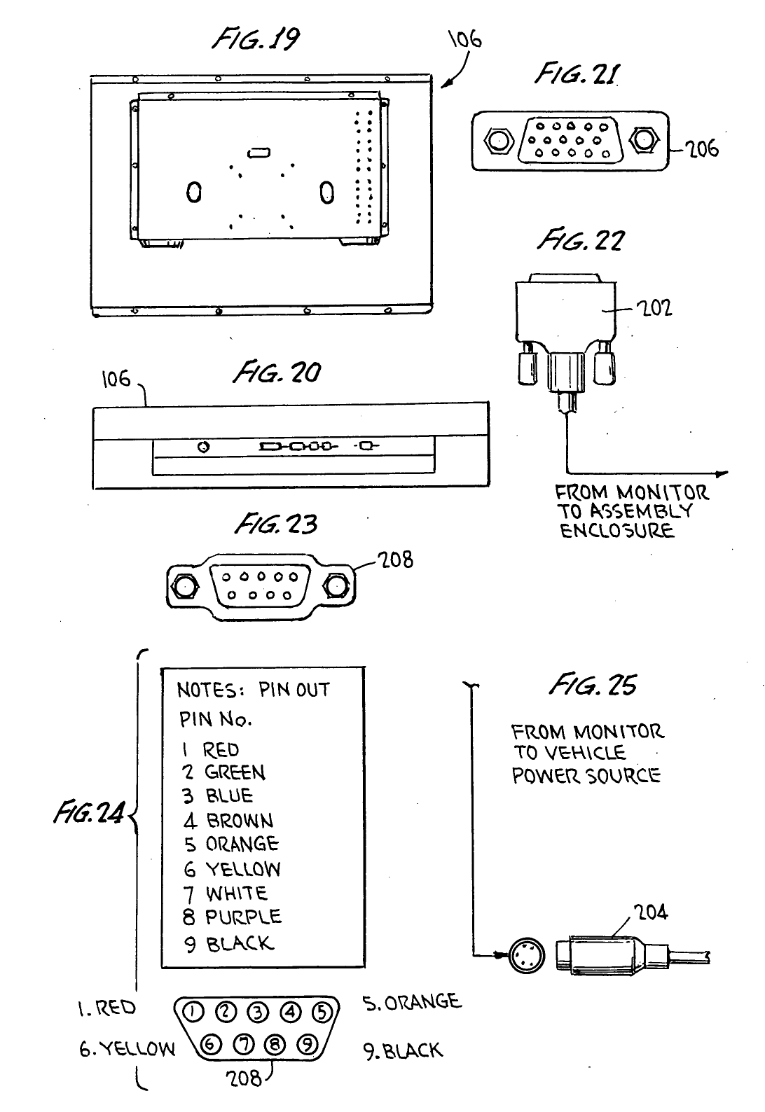

Referring to the FIGURES, FIG. 1 illustrates an overall schematic layout of a first embodiment of a mobile control system 100 of the present invention. FIG. 2 illustrates an overall schematic layout of a second embodiment of a mobile control system 100 of the present invention. As shown, for example, in FIGS. 1 and 2, the mobile control system 100 comprises cabin based components 102 and an assembly enclosure 104 having various components. The cabin based components 102 preferably include seat driven selection devices such as passenger modules 124, viewing monitors 106, speakers 108, amplifiers 110, at least one subwoofer 112, various antennas 114, at least one touch panel 116 for controlling the system, at least one microphone 118, at least one DVD player 120, at least one flash card reader 122, an ECU 174, a control processor 176, and the like. The various antennas 114 preferably include a GPS antenna 130, an extended module (XM) antenna 132, and/or a satellite antenna 134. The cabin based components 102 also include a MAS unit 260. The MAS unit 260 is a component that ties into the passenger modules 124 and/or the speakers 108 to provide audio to the individual head sets located at each seat in cabin of vehicle. The MAS unit 260 provides audio up and down adjustment as well as a channel selector button with a liquid crystal display (LCD) to display which channel has been selected. Each of the cabin based components 102 is described in greater detail hereafter.

The assembly enclosure 104 houses components of the mobile control system 100 that enable video and audio switching, controlling, and presenting; various receivers such as satellite receiver, a GPS receiver and an XM receiver; and a computer. Each of the components of the assembly enclosure 104 is described in greater detail hereafter.

A preferred embodiment of an assembly enclosure 104 is shown, for example, in FIGS. 3 and 4 and includes a video sync sensor module 140, a converter 142, a satellite receiver 144, a satellite in-door unit (IDU) 146, a computer 148, a GPS tracking system receiver 150, a XM receiver 152, a mixer 154, a matrix switcher 156, a power strip 158, a network terminal block (CNT block) 160, a universal presentation processor 162, a bus control system 164, and a scaler 166. Each of these components is described in greater detail hereafter.

The components of the assembly enclosure 104 are preferably housed in an assembly chassis 300 such as shown, for example, in FIGS. 3 and 6. The assembly chassis 300 includes a front cover 302 and a chassis base 304 on which the components of the assembly enclosure 104 are mounted. As shown, for example, in FIGS. 3 and 6, the front cover 302 preferably includes a front cover panel 306 with an assembly access cover panel 308, a top cover panel 310, a bottom cover panel 312, and two side wall panels 314. A side wall panel 314 is shown, for example, in FIG. 7. FIG. 8 shows a perforated screen ventilation which is located on each side of the assembly enclosure 104 to allow air flow and/or heat reduction. The assembly access cover panel 308 enables a user to have access to the components of the assembly enclosure 104 without completely removing the front cover 302 of the assembly chassis 300.

The components of the assembly enclosure 104 are mounted on the chassis base 304 by any suitable means. However, each component may preferably be secured in position in the assembly enclosure 104 by a suitable mounting plate which aids in securing the respective component to the chassis base 304. Embodiments of preferred mounting plates are shown, for example, in FIGS. 3 and 9-18. More particularly, FIG. 9 is a preferred embodiment of amounting plate 320 for an XM receiver 152. FIG. 10 is a preferred embodiment of a mounting plate 322 for a matrix switcher 156. FIG. 11 is a preferred embodiment of a mounting plate 324 for a mixer 154. FIG. 12 is a preferred embodiment of a mounting plate 326 for a universal presentation processor 162. FIG. 13 is a preferred embodiment of a mounting plate 328 for a scaler 166. FIG. 14 is a preferred embodiment of a mounting plate 330 for a satellite receiver 144. FIG. 15 is a preferred embodiment of a mounting plate 332 for a video sync sensor module 140. FIG. 16 is a preferred embodiment of a mounting plate 334 for a computer 148. FIGS. 17 and 18 illustrate a preferred embodiment of a mounting bracket 336 for a power strip 158. While preferred embodiments of mounting plates are described above and shown in FIGS. 3 and 9-18, any suitable mounting member may be used to aid in securing each component of the assembly enclosure 104 to the chassis base 304 of the assembly chassis 300.

The assembly enclosure 104 is preferably mounted in a mass transit vehicle with suitable brackets 316 or any other suitable member. The assembly enclosure 104 is preferably mounted in the mass transit vehicle in any suitable location including, but not limited to, a luggage bay, or any other bag/open area, preferably in the front or rear of the vehicle.

A second embodiment of an assembly enclosure 104 of the mobile control system 100 is shown, for example, in FIGS. 5A and 5B. The assembly enclosure 104 of FIGS. 5A and 5B preferably includes a video sync sensor module 140, a satellite receiver 144, a satellite IDU 146, a converter 142, a computer 148, a GPS receiver 150, two XM receivers 152, a satellite radio splitter 168, a mixer 154, a power strip 158, a matrix switcher 156, an ethernet hub 170, a universal presentation processor 162, a bus control system 164, a network terminal block 160, and a scaler 166.

The ethernet hub 170 is preferably a 5-port ethernet hub and provides a data link to the bus control system 164, the universal presentation processor 162, the computer 148 and the mixer 154. Also, a wireless device may optionally be connected to provide data communication for Internet access and messaging text from an operations center to the vehicle.

While the embodiments of the assembly enclosure 104 shown in FIGS. 3-5B illustrate preferred positioning of the components on the chassis base 304, the components of the assembly enclosure 104 may be operatively positioned in any suitable arrangement and/or location on the chassis base 304. Additionally, each component of the assembly enclosure 104 is preferably connected to at least one other component in the assembly enclosure 104 and/or at least one cabin based component 102 as detailed hereafter.

As shown in FIGS. 1 and 2, the cabin based components 102 of a mobile control system 100 include at least one monitor 106. The at least one monitor 106 may be any suitable monitor including, but not limited to, a liquid crystal display (LCD) monitor. LCD is a type of display used in many portable computers. LCD displays utilize two sheets of polarizing material with a liquid crystal solution therebetween. An electric current passed through the liquid causes the crystals to align so that light cannot pass through them. Each crystal, therefore, is like a shutter, either allowing light to pass through or blocking the light.

In a preferred embodiment, the cabin based components 102 include a plurality of monitors 106 and each passenger of the vehicle may have access to a monitor 106. The monitors 106 may be operatively positioned in any suitable location including in the back of a seat, suspended from the ceiling of the vehicle in front of each passenger or in the front of the vehicle. A monitor 106 may also be located in the luggage bay on both sides of the vehicle such that the monitor would only be seen when the vehicle is stopped or at a destination.

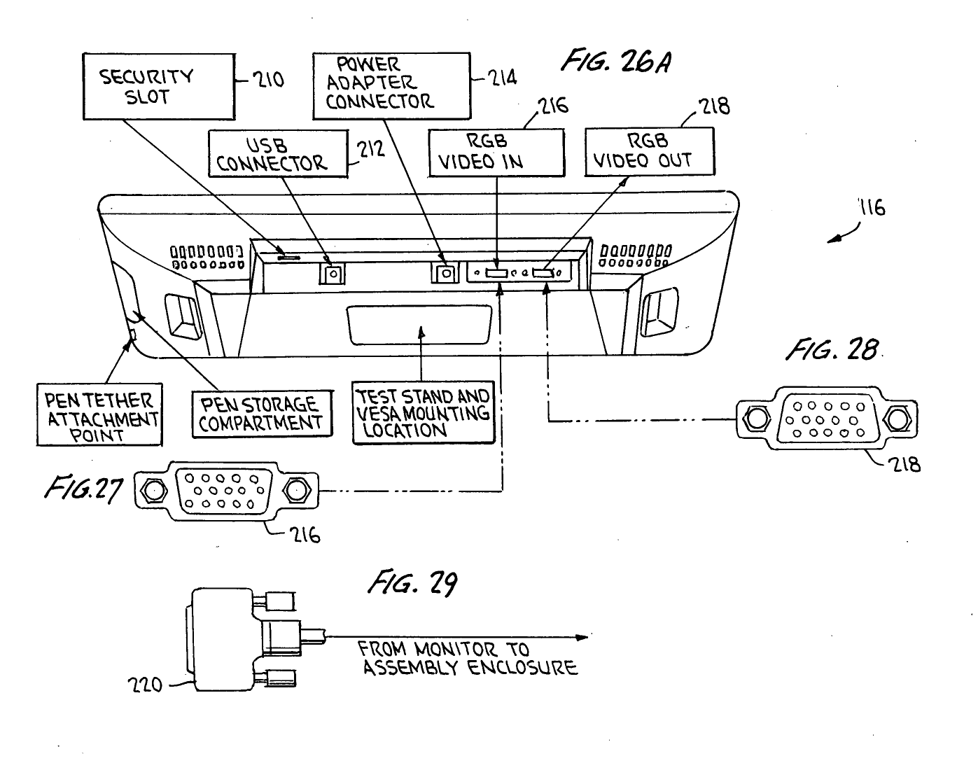

A preferred example of a monitor 106 is shown, for example, in FIGS. 19 and 20. Each monitor 106 is preferably connected to the assembly enclosure 104 by means of a cable connection. The cable connection may be any suitable cable and connector. A preferred embodiment of a cable port 206 of a monitor 106 is shown, for example, in FIG. 21. A preferred embodiment of cable connector 202 is shown, for example, in FIG. 22. The cable connector 202 connects the monitor 106 to the assembly enclosure 104. Another embodiment of a cable pin connector 208 is shown, for example, in FIGS. 23 and 24. Particularly, FIG. 24 illustrates the pin numbers and wire colors associated therewith for the cable pin connector 208. A preferred embodiment of a cable connector 204 which connects a monitor 106 to a vehicle power source is shown, for example, in FIG. 25.

The cabin based components 102 of the mobile control system 100 include at least one passenger module 124, but preferably include a plurality of passenger modules 124 such that each passenger of the vehicle may have access to a passenger module 124. The passenger modules 124 may be operatively positioned in any suitable location including in the back of a seat, suspended from the ceiling of the vehicle in front of each passenger, in an arm rest of the seat and/or in the modesty panel or console. In a preferred embodiment, the passenger modules 124 include a viewing monitor 106, such as detailed above, and/or a touch panel 116 as detailed hereafter

At least one touch panel 116 may be operatively positioned in the cabin of the vehicle, such as on the dashboard or console of the vehicle, in the back of a seat, suspended from the ceiling of a vehicle in front of each passenger, and/or in the front of the vehicle. The at least one touch panel 116 may be a wireless touch panel such as a RF, WI-FI®, or Bluetooth® touch panel. However, the touch panels 116 may be any suitable touch panel. In a preferred embodiment, each touch panel 116 has a user-interface for multimedia presentation, video conferencing, lighting, climate control, and the like, providing custom control screens which can be tailored to the needs of the end user. Touch panels 116 eliminate the need for items such as remote controls, cryptic front panels, and wall switches. The touch panels 116 provide one-touch control over a broad range of devices. Each touch panel 116 provides a primary user interface for the universal presentation processor 162, displays high resolution red/green/blue (RGB) video from the universal presentation processor 162, features a bright colored display, employs technology to support touch panel control and pen based annotation as part of a universal presentation processor system, provides a video electronic standards association (VESA) mount location, provides a security slot, includes a pen tether and includes a table top stand with tilt adjustment.

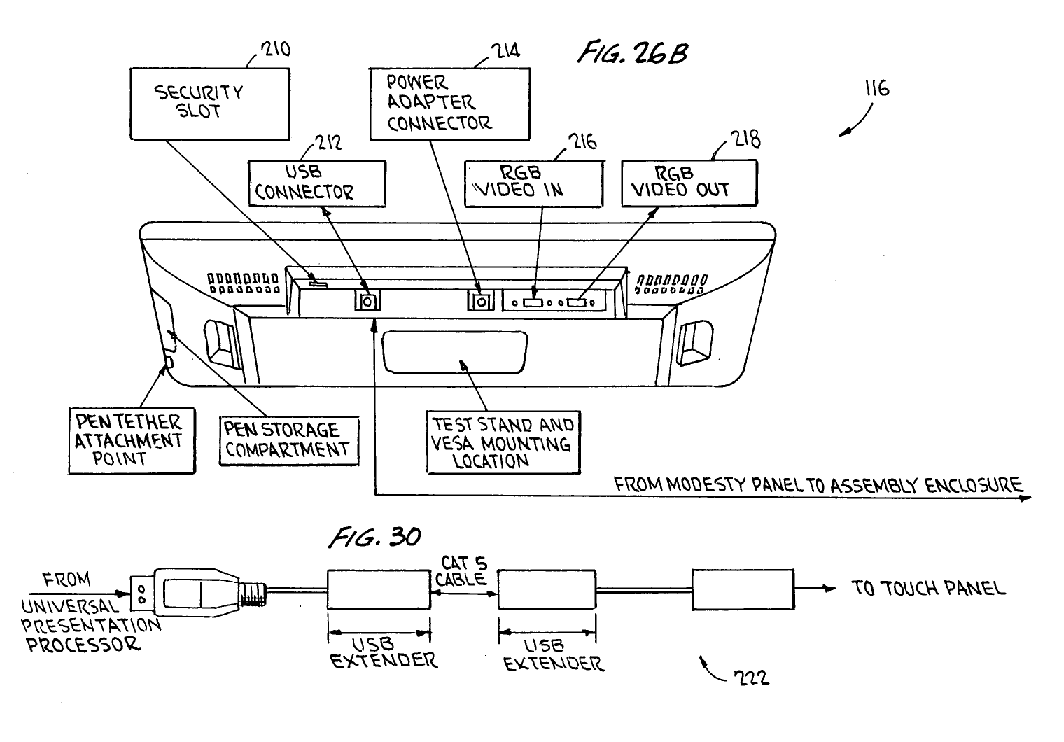

A preferred embodiment of a touch panel 116 preferably includes various ports such as shown, for example, in FIGS. 26A and 26B. The ports on the back of the touch panel 116 preferably include a security slot 210, a USB connector port 212, a power adaptor connector port 214, a RGB video in port 216 and a RGB video out port 218. The security slot 210 is an industrial standard that gives end users physical security for a computer and electronic equipment. To prevent unauthorized removal, a user can attach one end of a security cable to the security slot 210 and the other end to an immovable object, thus providing physical security for the device. FIG. 27 illustrates a preferred embodiment of the RGB video in port 216. FIG. 28 illustrates a preferred embodiment of the RGB video out port 218. FIG. 29 illustrates a preferred embodiment of a cable connector 220 which connects the RGB video in port 216 and/or the RGB video out port 218 on the touch panel 116 to the assembly enclosure 104. The RGB video in port 216 preferably connects to the universal presentation processor 162 in the assembly enclosure 104. The RGB video out port 218 may be a spare port for future expansion of the system. FIG. 30 illustrates a preferred embodiment of a cable connection 222 which connects the USB connector port 212 of the touch panel 116 to the universal presentation processor 162 in the assembly enclosure 104. The power adaptor connector port 214 preferably connects to a power supply from the vehicle by a suitable connection such as a cable.

FIG. 31 illustrates a second embodiment of a touch panel 116 of the mobile control system 100 of the present invention. The touch panel 116 of FIG. 31 is preferably complete with integrated audio and video. The touch panel 116 provides user interface for multimedia presentation, video conferencing, lighting, climate control, and the like, providing a means for creation of custom control screens tailored to the needs of the end user. As detailed above, the touch panels 116 preferably eliminate or limit the need for remote controls, front panels, and wall switches, providing a one touch control over a broad range of complex devices and systems.

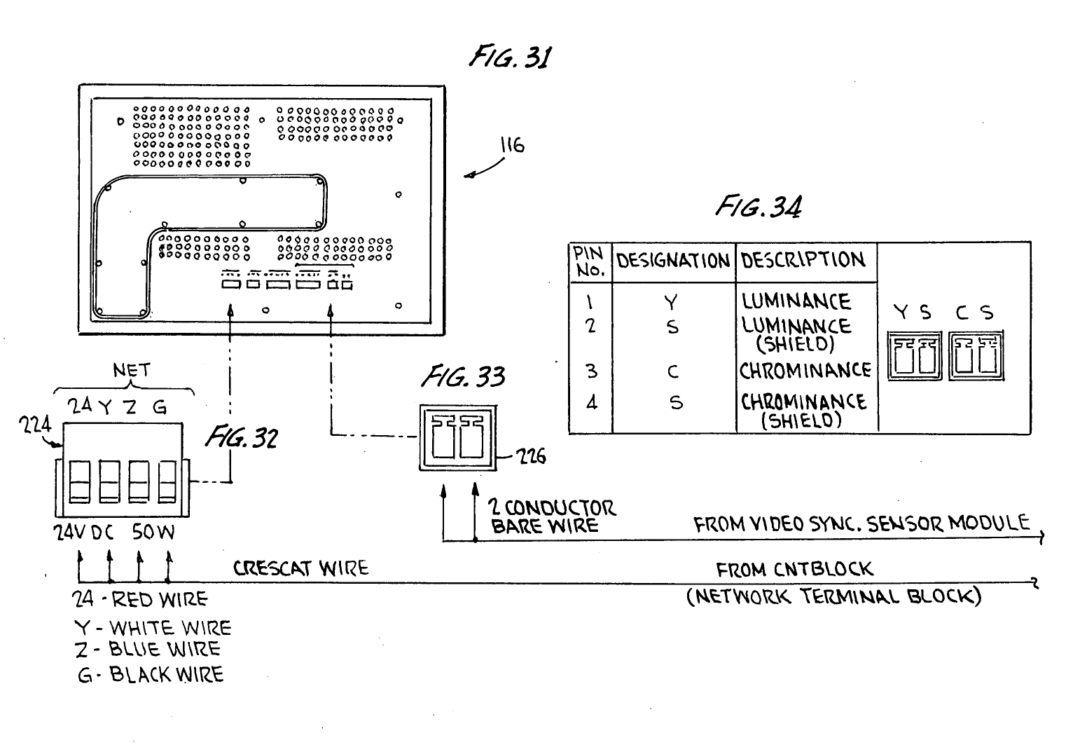

FIG. 32 illustrates a preferred embodiment of a net connector port 224 on the back of the touch panel 116 of FIG. 31. The net connector port 224 connects the touch panel 116 of FIG. 31 with the network terminal block 160 in the assembly enclosure 104. FIGS. 33 and 34 illustrate a preferred embodiment of a national television systems committee/phase alternating line (NTSC/PAL) video input port 226 which connects the touch panel 116 with the video sync sensor module 140 in the assembly enclosure 104.

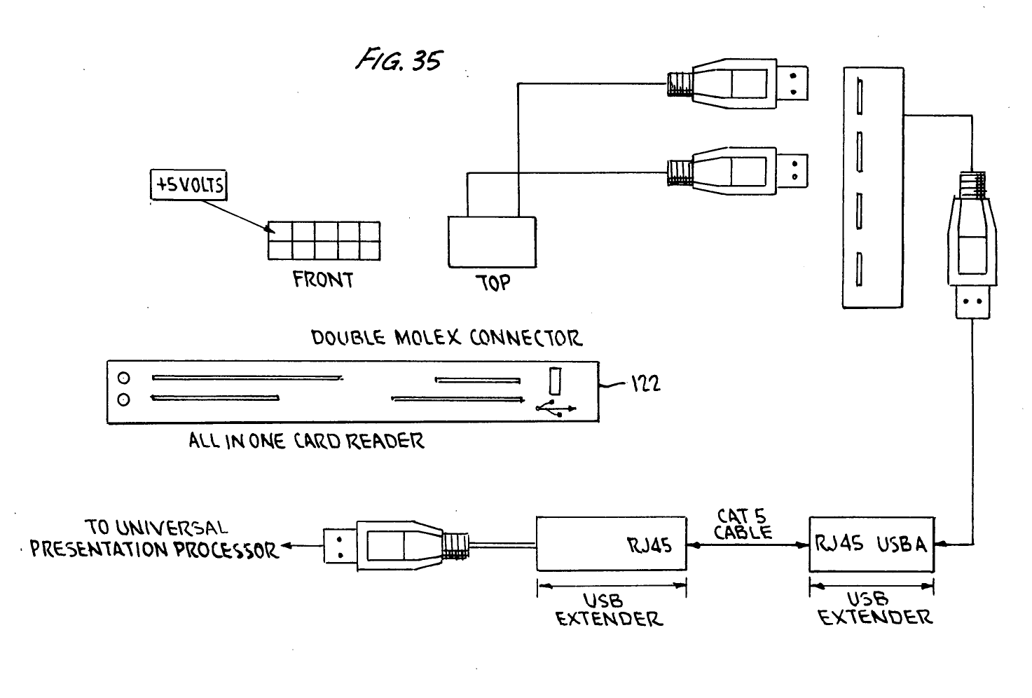

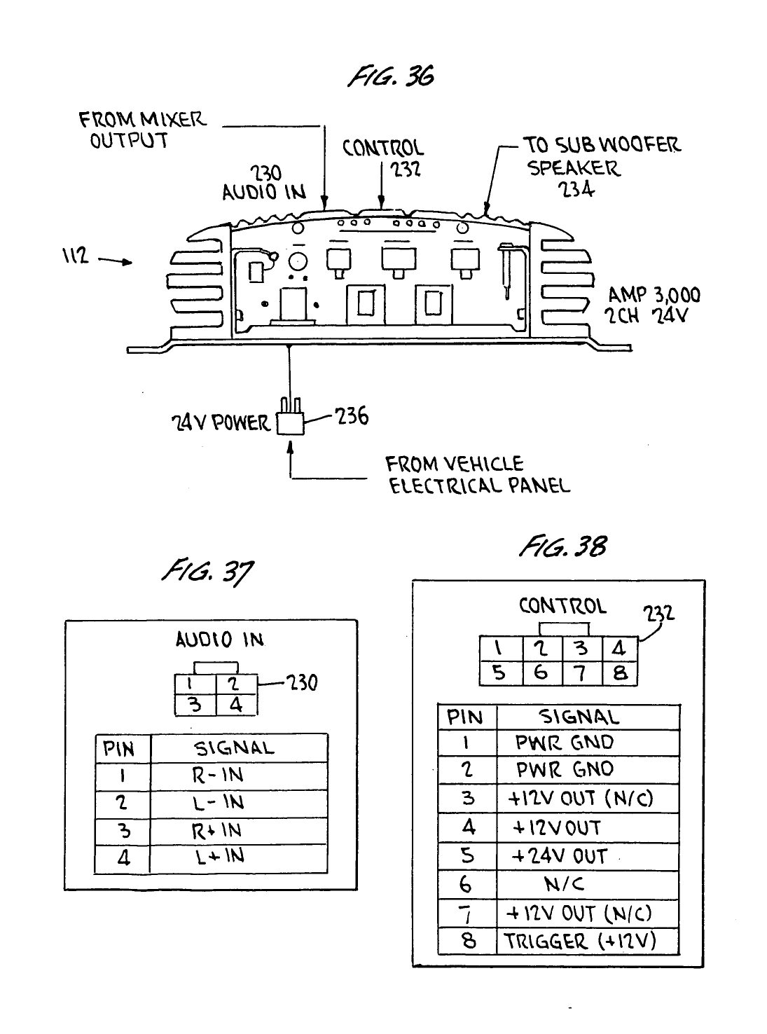

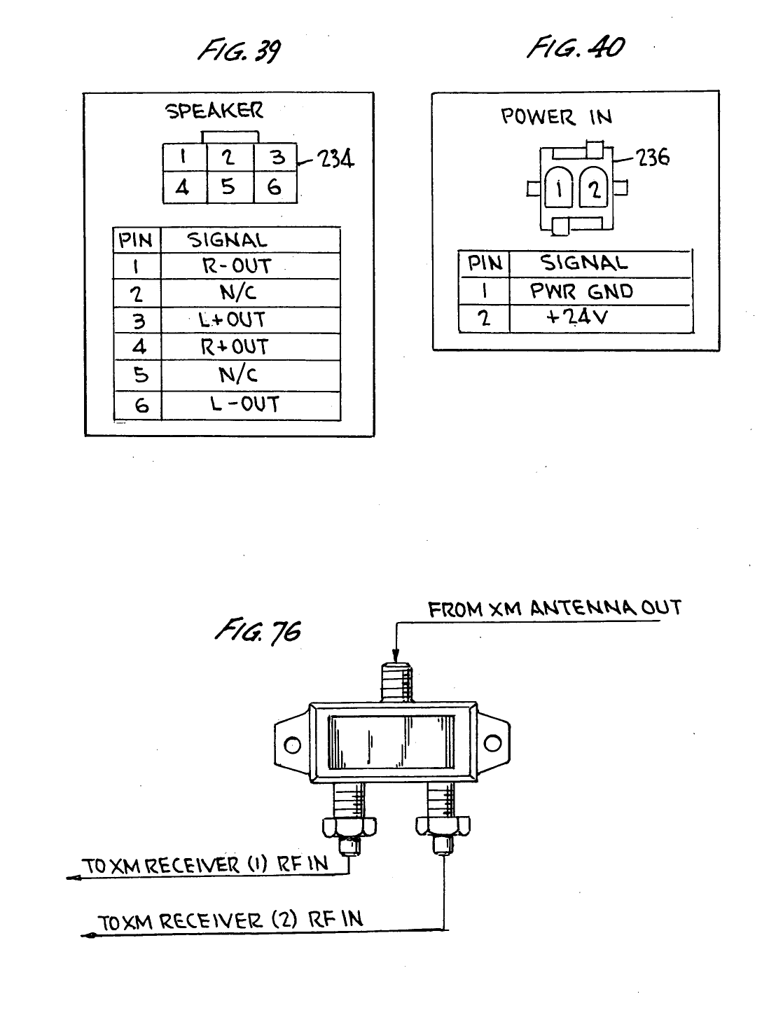

FIG. 35 illustrates a preferred embodiment of a flash card reader 122 of the mobile control system 100. The flash card reader 122 is preferably located on a modesty/control panel in the dashboard of a mass transportation vehicle. However, the flash card reader 122 may be operatively positioned in any suitable location. The flash card reader 122 preferably connects, by a cable such as an original equipment manufacturer (OEM) cable, having USB type ends, to a hub. The hub is then connected by a suitable cable to a USB extender which may then be connected by another suitable cable, such as a CAT 5 cable as known in the art, to a second USB extender and which may then be connected to the universal presentation processor 162 in the assembly enclosure 104. OEM is a manufacturer who resells another company's product under its own name and branding and offers its own warranty, support and licensing of the product.

USB is a universal serial bus standard to interface devices which was designed for computers but has expanded into use on video game consoles, personal digital assistants (PDAS) portable DVD and media players, cell phones, televisions, home stereo equipment, car stereos, portable memory devices and the like. USB was designed to enable peripherals to be connected without the need to plug extension cards into a computer's industry standard architecture (ISA), extended industry standard architecture (EISA), or peripheral component internet (PCI) bus, and to improve plug-and-play capabilities by allowing devices to be connected or disconnected by powering down or rebooting the computer. USB connects several devices to a host controller through a chain of hubs.

The flash card reader 122 functions to provide media presentations, to provide word processing, to provide spreadsheets, to display commercials, to download commercials, to update software such as in the universal presentation processor 162 or the bus control system 164, and to provide access to personal camera photos which can be displayed in the cabin of the vehicle.

The subwoofer amplifier 112 of the mobile control system 100 may be any suitable subwoofer. The subwoofer 112 is a type of loudspeaker designed to reproduce the lowest of audible frequencies, such as bass frequencies. A preferred embodiment of the ports of the subwoofer 112 is shown, for example, in FIG. 36.

The subwoofer 112 preferably includes the following ports: an audio in port 230, a control port 232, a speaker port 234, and a power in port 236. FIG. 37 illustrates a preferred embodiment of an audio in port 230 of the subwoofer 112 showing the signal designation for each pin. The audio in port 230 of the subwoofer 112 connects to a mixer output port on the mixer 154 in the assembly enclosure 104. A preferred embodiment of a control port 232 of the subwoofer 112 showing the signal designation for each pin is shown, for example, in FIG. 38. The control port 232 of the subwoofer 112 may be an open port which may be used to activate a remote switch that is internal to the device pin 4 and 8 in FIG. 38 and the control port 232 may be connected to a closed circuit. A preferred embodiment of a speaker port 234 showing the signal designation for each pin is shown, for example, in FIG. 39. The speaker port 234 preferably connects the subwoofer 112 to at least one speaker 108. A preferred embodiment of a power in port 236 of the subwoofer 112 showing the signal designation for each pin is shown, for example, in FIG. 40. The power in port 236 connects the subwoofer 112 to an electrical panel of a vehicle in which the mobile control system 100 is being used.

The subwoofer 112 is operatively positioned in any suitable location. However, the subwoofer 112 is preferably located in a luggage bay or within the cabin under any seat depending on the size of the speaker, and/or along a rear bench seat in the vehicle.

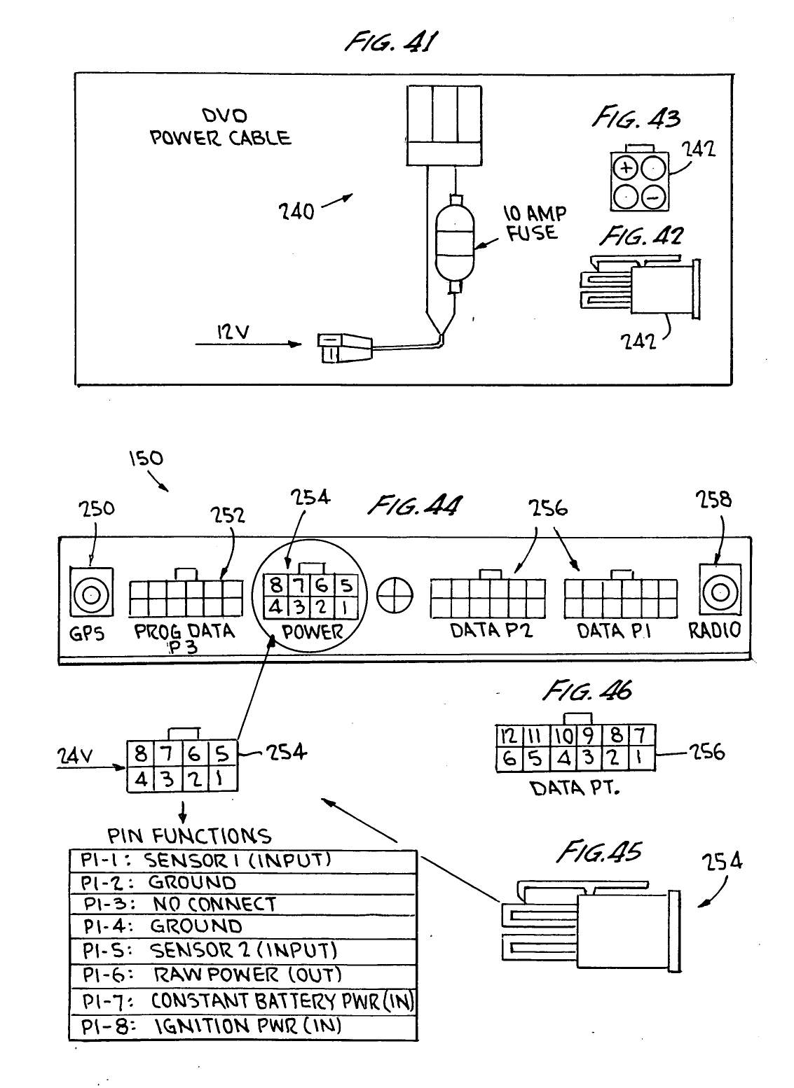

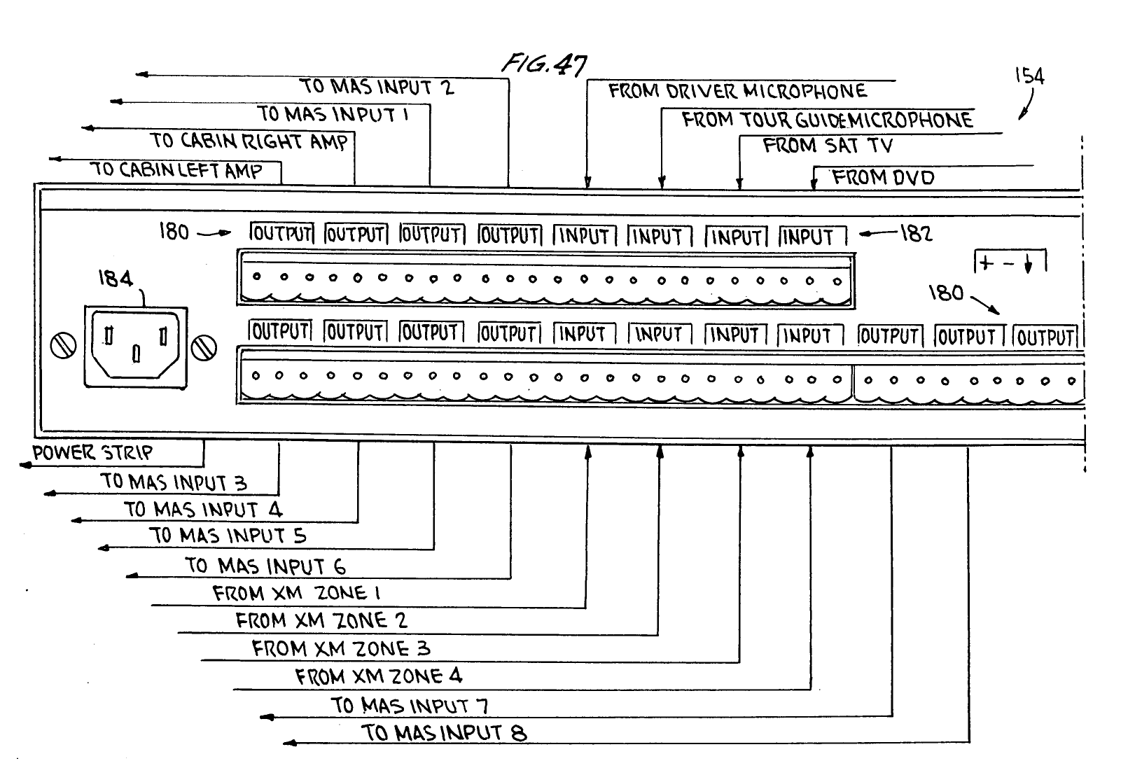

FIG. 41 is a preferred embodiment of a DVD power cable 240. FIG. 42 is a side view of a DVD power cable connector port 242. FIG. 43 is a front view of a preferred embodiment of the DVD power cable connector port 242. The DVD power cable connects the DVD player 120 to a power source such as a 12 volt vehicle power from the vehicle electrical panel.

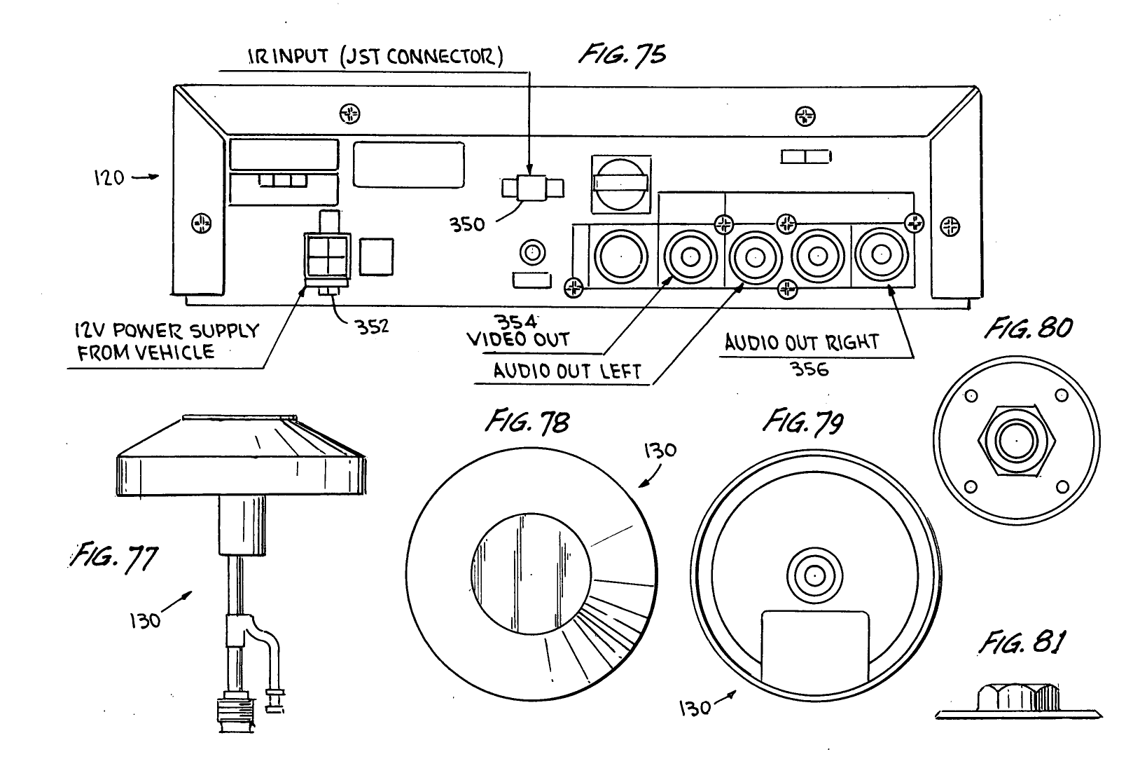

FIG. 75 illustrates a preferred embodiment of a DVD player 120 of the mobile control system 100. The DVD player 120 plays DVDs. The DVD player 120 has various ports including an infrared receiver (IR) input port 350 for providing control via a touch panel interface, a power supply port 352, various video out ports 354 and audio out ports 356, and other ports such as S-video, digital audio out, and external remote eye input (OEM cable) ports. The IR input port connects the DVD player 120 to the bus control system 164. The power supply port 352 connects the DVD player 120 to a power supply. The video out ports 354 connect the DVD player 120 to the video scaler 166 composite input. The audio out ports 356 connect the DVD player 120 to the mixer 154 at an input port. The DVD player 120 is preferably any suitable DVD player.

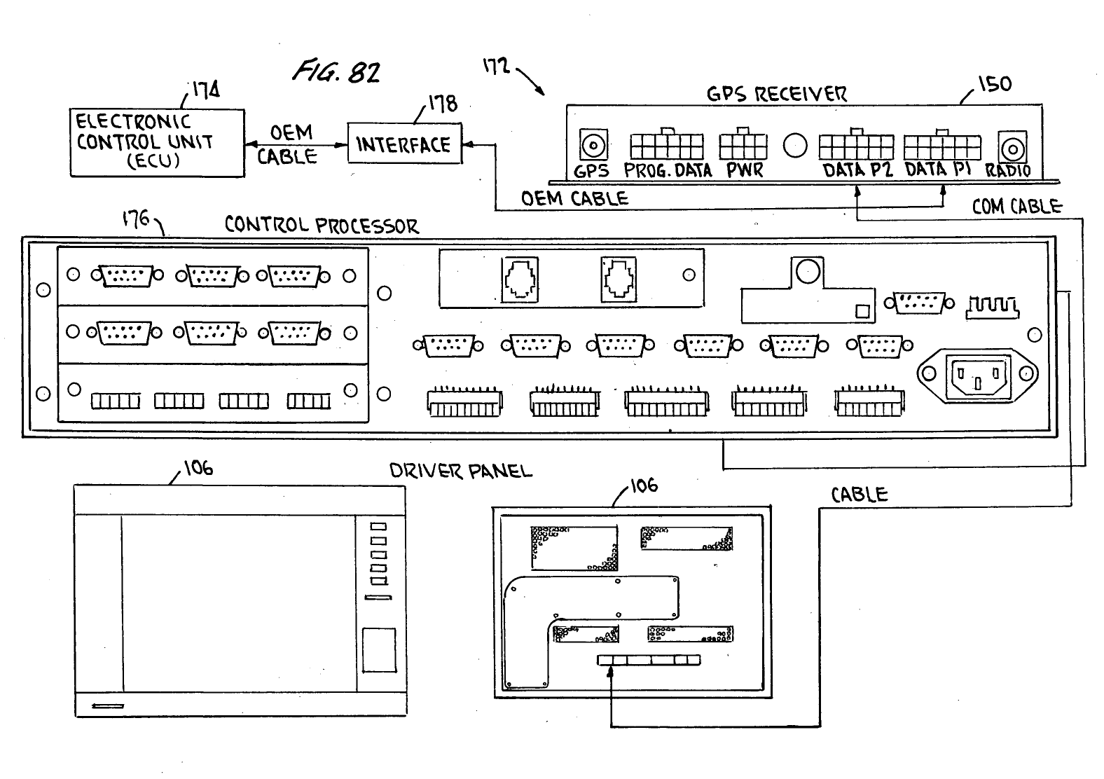

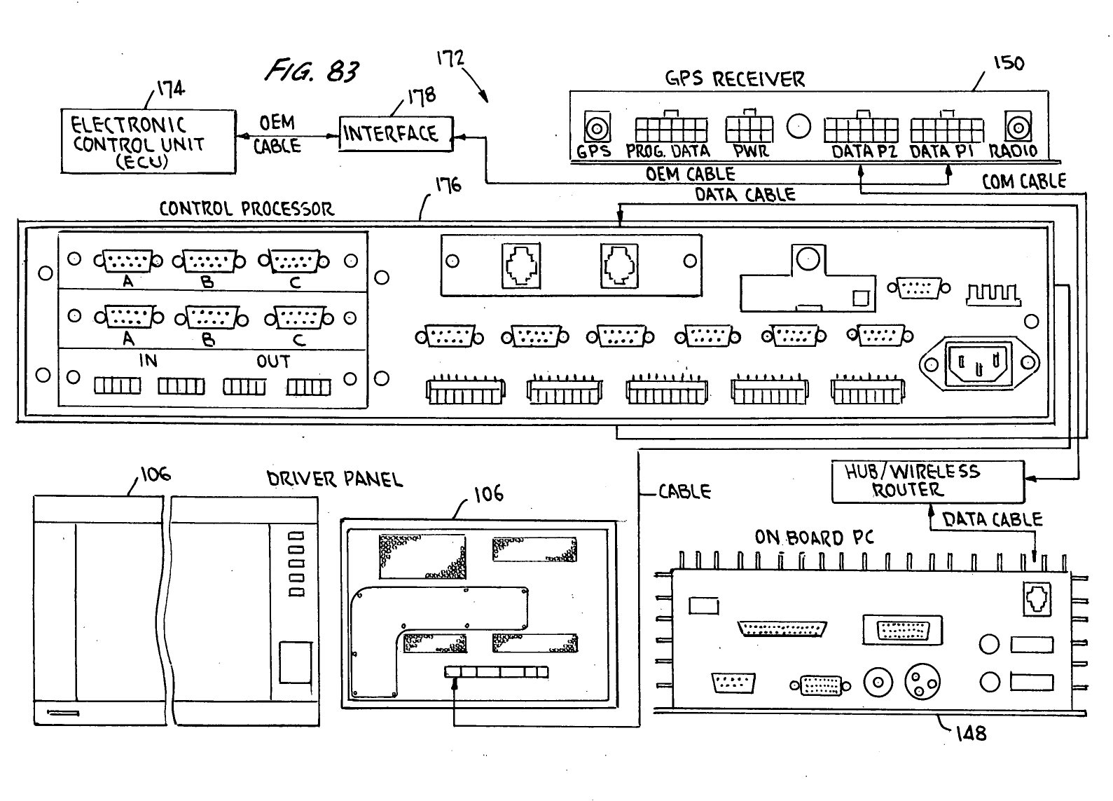

FIGS. 77-81 illustrate various views of a GPS antenna 130 of the mobile control system 100. The GPS antenna 130 is preferably a dual through-hole mount antenna with mounting holes. However, the GPS antenna 130 may be any suitable antenna. The GPS antenna 130 connects to the GPS receiver 150 to transmit GPS signals to the GPS receiver 150.

The XM antenna 132 may be any suitable antenna. The XM antenna 132 preferably connects to the XM receiver 152 and transmits XM signals to the XM receiver 152. Each XM receiver 152 preferably includes three individual/separate receivers, i.e., a total of six receivers.

The satellite antenna 134 may be any suitable antenna. The satellite antenna 134 preferably connects to the satellite receiver 144 and transmits satellite signals to the satellite receiver 144. The satellite antenna 134 and satellite receiver 144 may provide Internet access capability.

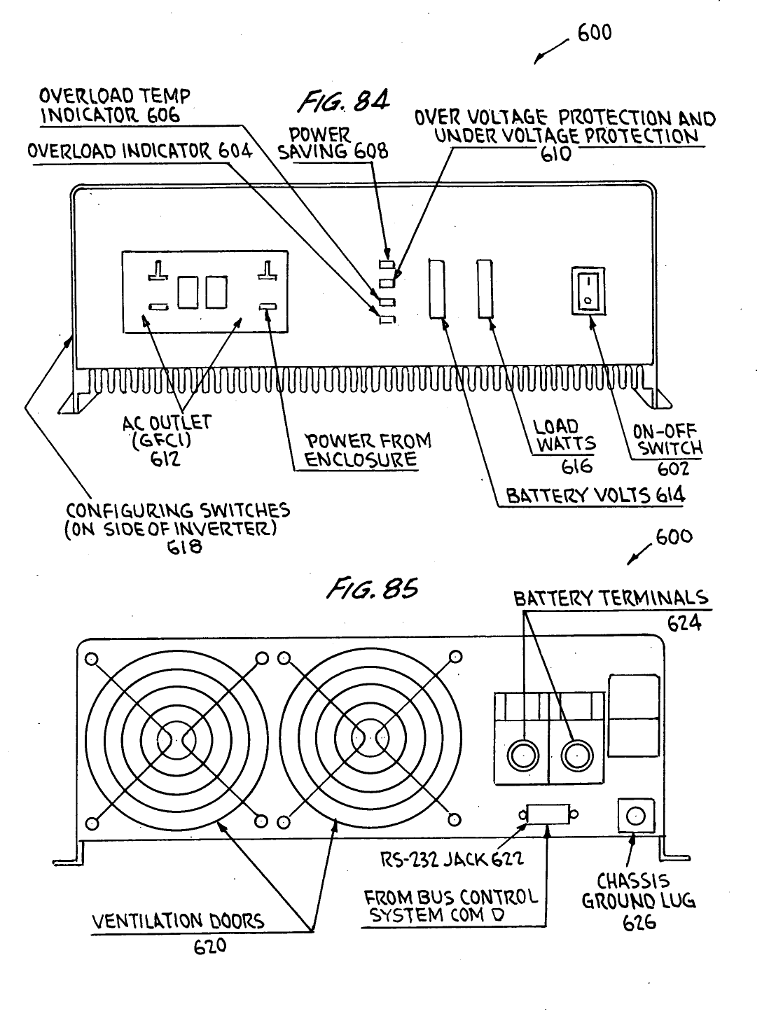

FIGS. 82 and 83 illustrate two embodiments of the driver assistance and direction system 172 of the mobile control system 100. The driver assistance and direction system 172 attaches to an electronic control unit (ECU) 174 and a control processor 176 which each connect to the GPS receiver 150 in the assembly enclosure 104 via an interface, such as a J1708 Interface, as known in the art. The driver assistance and direction system 172 provides a flow of information from the ECU 174 to at least a driver of the vehicle, a vehicle dispatch center and/or a predetermined manufacturer of vehicle parts when a fault or error occurs during normal operation of a mass transportation vehicle. The fault/error information is transmitted via the ECU 174 by way of the GPS receiver and optionally the on board computer 148 through a graphical user interface 178. The driver assistance and direction system 172 displays the fault/error code and information regarding the severity of the fault/error along with any steps or measures that need to take place when the fault/error occurs in the vehicle. For the driver, the information is displayed on a monitor 106 on the dashboard. With an Internet connection, the vehicle dispatch center and other parties such as a parts manufacturer and/or a mechanic will receive the same information as the driver in “near real time.” “Near real time” is relative to Internet connectivity, reception of cell service or signal strength of cell service. The driver can respond to a fault/error or service engine light while maintaining the safety of the passengers and the vehicle due to the driver assistance and direction system 172. The vehicle dispatch center will have the ability to respond to the information with mechanical assistance in a timely manner, thereby reducing the risk to passengers and the driver due to mechanical break down, such as along side of a road. Also, the parts manufacturer will be able to maintain an accurate inventory of vehicle parts in stock.

The control processor 176 and computer 148 provide the necessary programming to interpret the ECU data and then display the information on the monitors 106. This program resides on either the control processor 176 or the computer 148 depending on the size of the program.

As shown, for example, in FIG. 82, the driver assistance and direction system 172 has an ECU 174 which connects to the interface 178 which connects to the GPS receiver 150, such as the data P1 port on the GPS receiver 150. The data P2 port on the GPS receiver 150 then connects the GPS receiver 150 to a communication port on the control processor 176. A net port on the control processor 176 connects the control processor 176 to a driver panel monitor 106 or other end user monitor.

In another embodiment as shown, for example, in FIG. 83, the control processor 176 of the driver assistance and direction system 172 may also optionally be connected to the computer 148 via a hub/wireless router. This connection provides the necessary data link for communication between the control processor 176, the computer 148 and the GPS receiver 150. This connection also provides a means to transmit information to operations centers, etc.

The speakers 108 of the mobile control system may be any suitable speakers and are preferably operatively positioned in the vehicle cabin or in an overhead compartment.

The microphone 118 may be any suitable microphone and be operatively positioned in any suitable location.

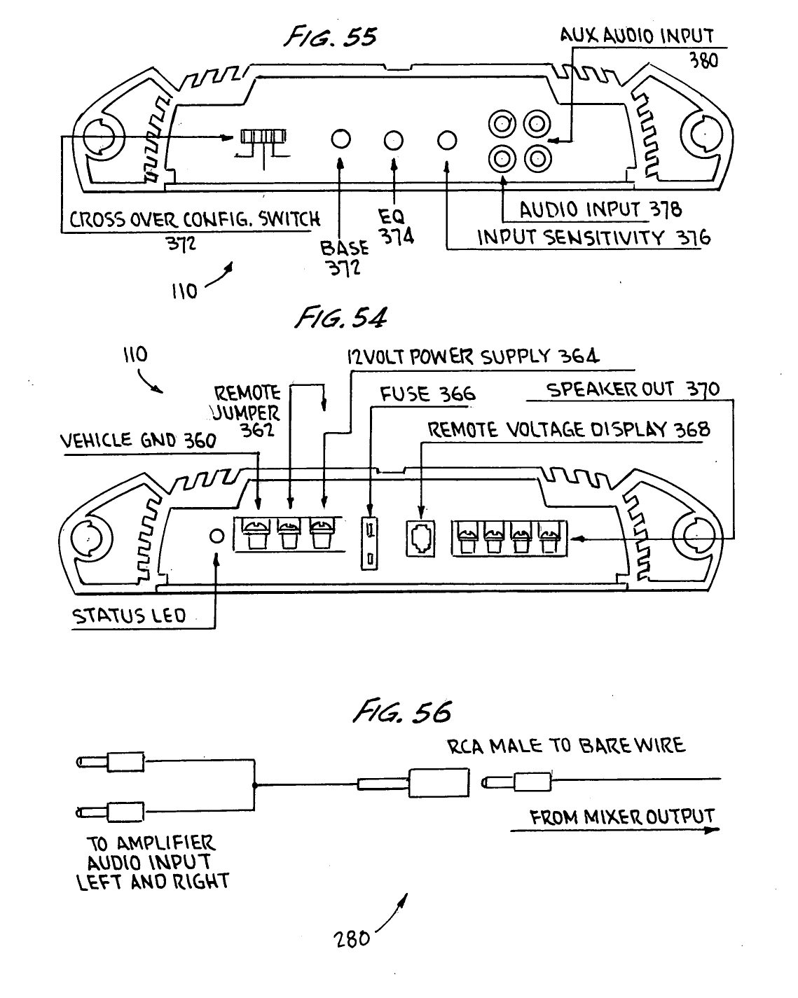

The mobile control system 100 includes at least one amplifier 110. A first embodiment of an amplifier 110 of the mobile control system 100 is shown, for example, in FIGS. 54 and 55. The amplifier 110 increases the voltage, current and power of the audio and video of the mobile control system 100. The amplifier 110 preferably includes various ports including a vehicle ground port 360, a remote jumper port 362, a power supply port 364, a fuse 366, a remote voltage display port 368, and speaker out ports 370. The vehicle ground port 360 connects the amplifier 110 to the chassis ground via the vehicle electrical panel. The remote jumper port 362 connects the amplifier 110 to the remote turn-on terminal of a phoenix gold amplifier. The power supply port 364 connects the amplifier 110 to a vehicle power supply. The remote voltage display port 368 is an open port capable of enabling expansion of the system. The speaker out port connects the amplifier 110 to the speakers 108. The back of the amplifier 110 also includes controls or ports such as a crossover configuration switch 372, a base control 372, an equalizer (EQ) control 374, an input sensitivity control 376, an audio input port 378 and an auxiliary audio input port 380. These controls allow various audio adjustability within the range or level of the amplifier and provides tuning capability for audio quality.

FIG. 56 illustrates a preferred embodiment of a cable connector 280 which connects the audio input port 378 of the amplifier 110 to the mixer 154 in the assembly enclosure 104.

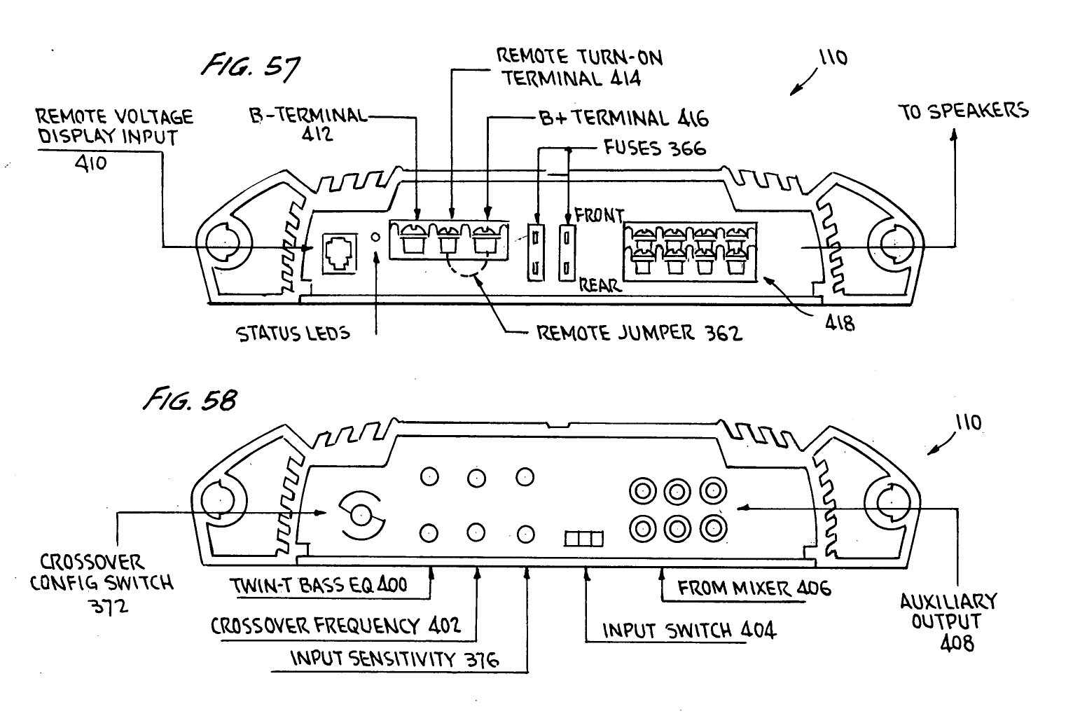

FIGS. 57 and 58 illustrate a second embodiment of an amplifier 110 of the mobile control system 100. The amplifier 110 of FIGS. 57 and 58 includes various controls including a crossover configuration switch 372, a twin-T bass EQ control 400, a crossover frequency control 402, an input sensitivity control 376, and an input switch 404. These controls allow various audio adjustability within the range or level of the amplifier and provides tuning capability for audio quality. The amplifier 110 of FIGS. 57 and 58 also includes various ports 406 which connect the amplifier 110 to the mixer 154 and also includes an auxiliary output port 408 which connects the amplifier 110 to the subwoofer amplifier 112 which provides an audio passthrough capability with a full range of audio level control. The amplifier 110 also includes status LEDs, a remote voltage display input port 410, a B-terminal (vehicle ground) port 412, a remote turn-on terminal port 414, a B+ terminal (battery positive) port 416, a fuse 366, a remote jumper port 362, and various ports 418 which connect the amplifier 110 to the speakers 108. These ports/controls allow various audio adjustability within the range or level of the amplifier and provides tuning capability for audio quality.

The components of the assembly enclosure 104 are described in greater detail hereafter.

A preferred embodiment of a GPS tracking system receiver 150 is shown, for example, in FIG. 44. The GPS receiver 150 is operatively positioned in the assembly enclosure 104. The GPS tracking system receiver 150 may be any suitable GPS receiver. The GPS receiver 150 receives GPS signals from the GPS antenna 130 and the GPS receiver 150 enables a user to keep track of mobile assets, improve efficiency, and customer service and gain valuable management information. The benefits of a GPS tracking system includes: reduced fuel consumption; enhanced productivity by measuring-stop and travel time; providing better service for customers; easily track mileage, actual routes and current location of vehicles; and reduces maintenance costs and downtime.

The GPS receiver 150 has various ports such as shown in FIG. 44 including a GPS port 250, a program data port 252, a power port 254, at least one data port 256, and a radio port 258. A GPS antenna 130 connects to the GPS port 250 of the GPS receiver 150. The program data port 252 connects to the GPS port 250 and the radio port 258 connects to the GPS antenna 130. The power port 254 connects the GPS receiver 150 with a power source. FIG. 45 illustrates a side view of a preferred embodiment of a power port 254 of the GPS receiver 150. The power port 254 connects to a vehicle 12 volt power supply via an electrical panel. FIG. 46 illustrates a preferred embodiment of a data port 256 of the GPS receiver 150. At least one data port 256 connects to the interface 178, e.g., a J1708 Interface, in the driver assistance and direction system 172. In FIG. 44, port data P1 receives the ECU data information via interface 178; port data P2 may be used in conjunction with the driver assistance and direction system 172; data port P3 is open and available for sensor type expansion such as an occupancy calculator.

FIG. 47 shows a preferred embodiment of a mixer 154 of the mobile control system 100. The mixer 154 provides all the necessary audio control within the system to include, but not limited to: all audio inputs, XM, SAT TV, DVD player, and flash media audio. The mixer 154 provides all audio matching functions, microphone inputs and computer audio. The mixer 154 supplies the MAS system audio and allows audio level adjustments for microphone cabin amplifiers and the MAS unit, such as gain, echo cancellation, and noise cancellation. The mixer 154 has various ports, such as, various output ports 180 and input ports 182, and a power strip port 184. The power strip port 184 of the mixer 154 connects to the power strip 158 in the assembly enclosure 104. The output ports 180 and input ports 182 may be connected in any suitable arrangement or manner and to any suitable components. An example of the connections of the output ports 180 and the input ports 182 of the mixer 154 to other components is as follows. For example, output port 1 preferably connects to an amplifier; output port 2 connects to an amplifier; output port 3 connects to a first MAS input port; output port 4 connects to a second MAS input port; output port 5 connects to a third MAS input port; output port 6 connects to a fourth MAS input port; output port 7 connects to a fifth MAS input port; output port 8 connects to a sixth MAS input port; output port 9 connects to a seventh MAS input port; and output port 10 connects to an eighth MAS input port. Input port 1 connects to a driver microphone 118; input port 2 connects to a second microphone 118; input port 3 connects to a satellite television receiver 154; input port 4 connects to a DVD player 120; input port 5 connects to a first zone of an XM receiver 152; input port 6 connects to a second zone of an XM receiver 152; input port 7 connects to a third zone of an XM receiver 152; input port 8 connects to a fourth zone of an XM receiver 152; input port 9 connects to a fifth zone of an XM receiver 152; input port 10 connects to a sixth zone of an XM receiver 152; input port 11 connects to a computer 148; and input port 12 connects to a universal presentation processor 162. However, the ports may be connected to any suitable component.

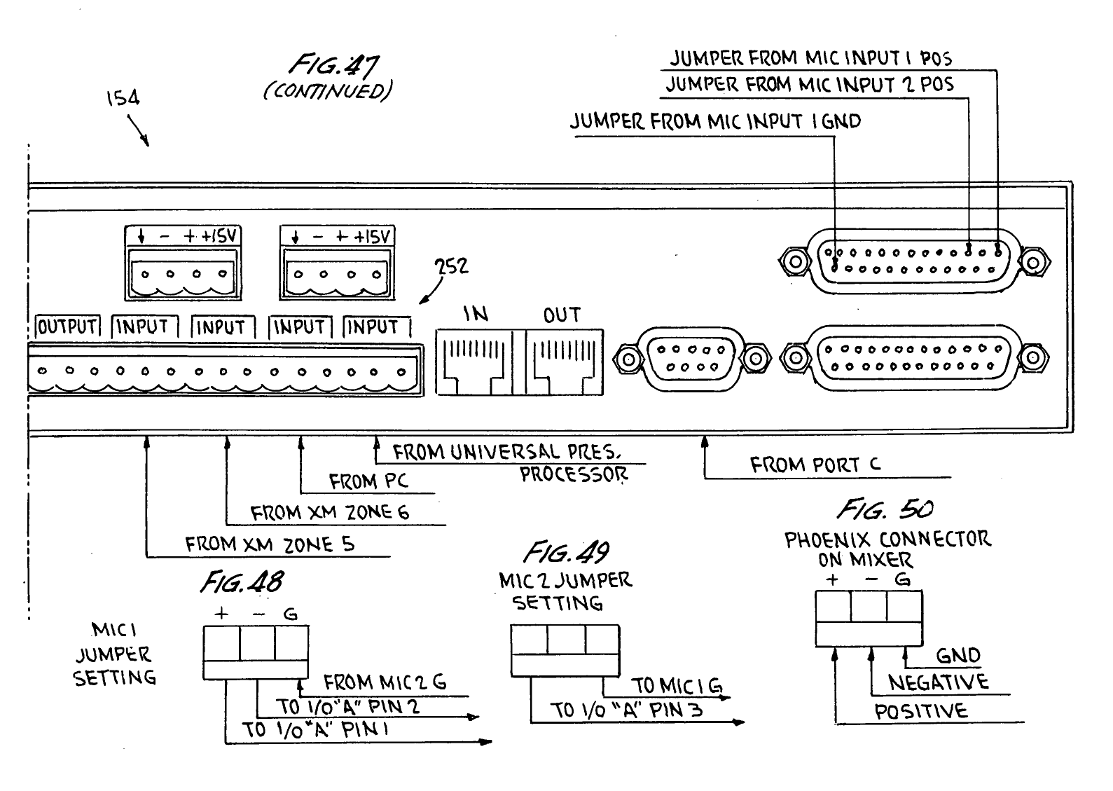

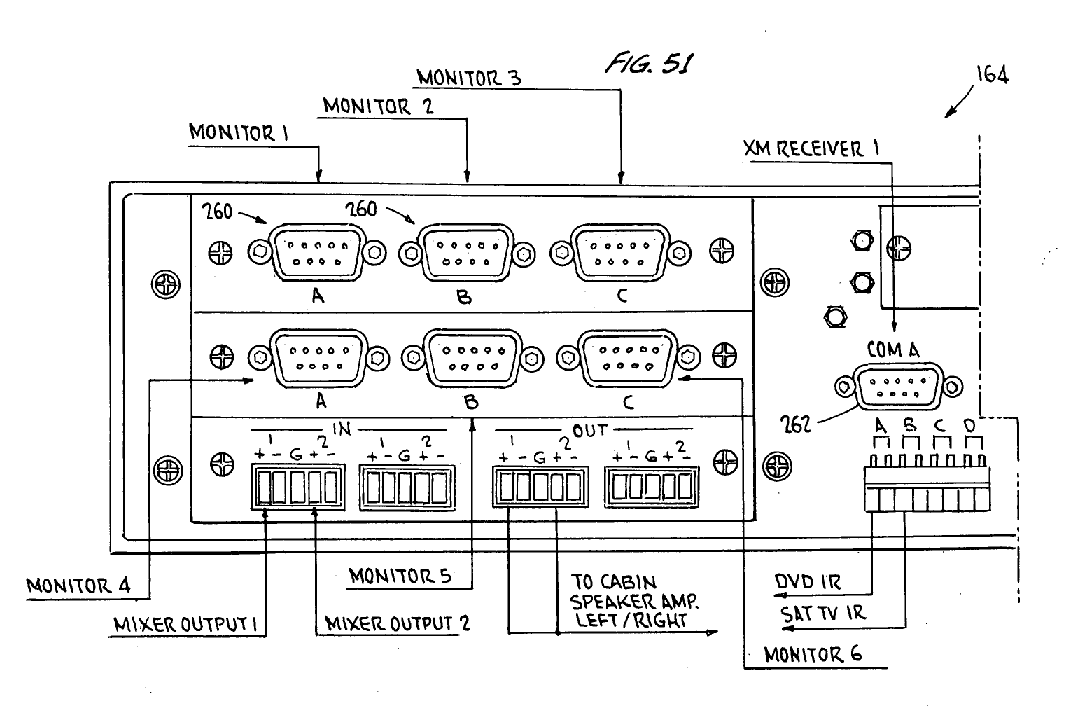

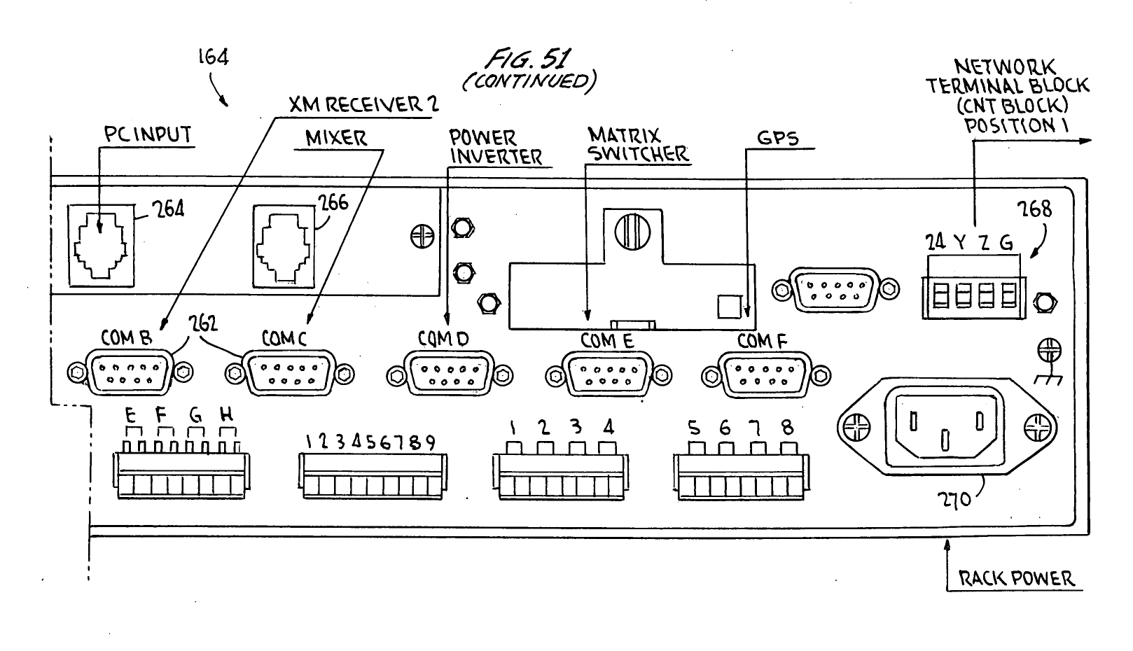

FIG. 48 shows a preferred embodiment of a first microphone jumper setting of the mixer 154. FIG. 49 shows a preferred embodiment of a second microphone jumper setting of the mixer 154. FIG. 50 shows a preferred embodiment of a phoenix connector on the mixer 154 of FIG. 47. The microphone jumper settings are set in such a way as to control audio within the cabin. Within the mixer, the program is written, set or predetermined so that the audio will automatically mute when the microphone is turned on and the audio resumes when the microphone is turned off. Power is needed to activate the port and is provided by the phoenix connector positive pin. Both passenger and driver microphones preferably work in the same fashion. There is only a need for one ground on port “A” due to the jumper or wire coming from microphone 2 phoenix connector. This is a “time saving” method/technique during installation.

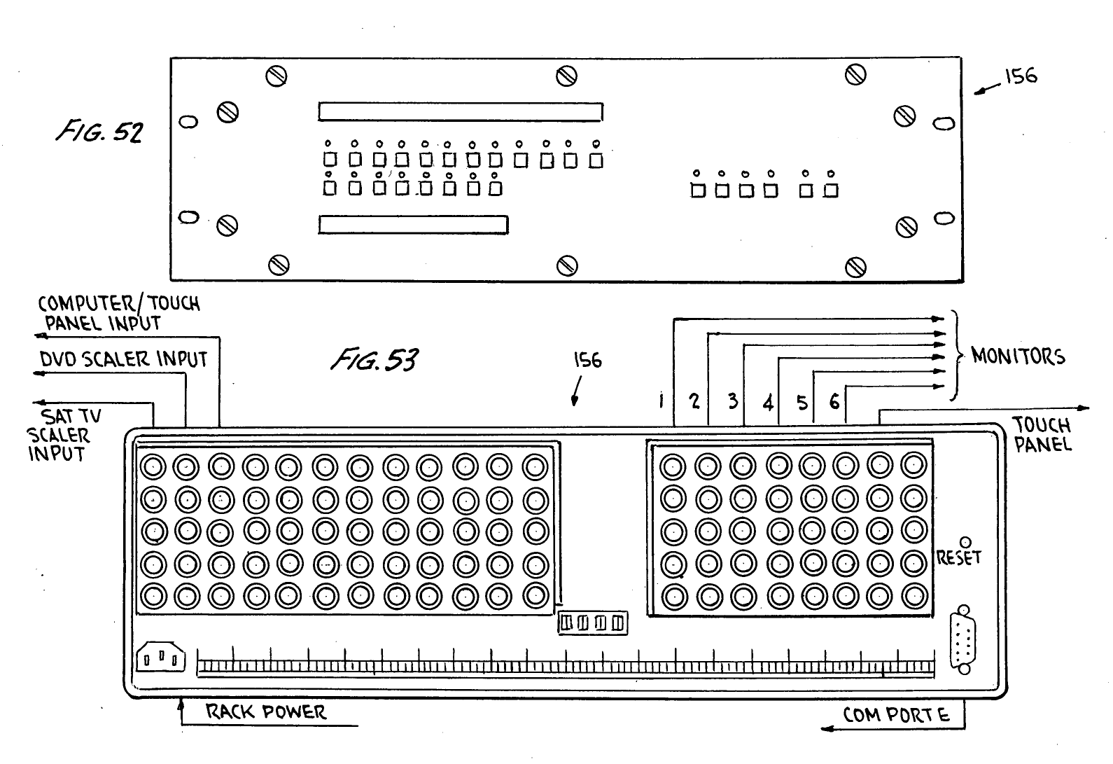

FIG. 51 illustrates a preferred embodiment of the bus control system 164 of the present invention. The bus control system 164 is a controlled technology that is also a network information control system. The bus control system 164 has high speed input/output (I/O) bus architecture which provides fast throughput system wide. The bus control system 164 allows for the input of high performance expansion cards and control cards and serves as the pipeline for inferred receiver (IR) serial communications and relays. The bus control system 164 also provides secure network communications with a variety of plug in ethernet cards. Using a dual port ethernet card, a built-in fire wall provides security with on board network address translator (NAT) and router functions. The bus control system 164 supports static internet protocol (IP) addressing and full duplex transmission control protocol/internet protocol (TCP/IP) and user datagram protocol/internet protocol (UDP/IP). TCP/IP is the suite of communications protocols used to connect hosts on the Internet. TCP/IP is built into the operating system and is used by the Internet, making it the de facto standard for transmitting data over networks. UDP/IP is a connectionless protocol that runs on top of IP networks. UDP/IP provides very few error recovery services, offering instead a direct way to send and receive datagrams over an IP network. It is used primarily for broadcasting messages over a network.

The bus control system 164 preferably has a built-in web server which provides various functions and uses memory storage on a compact flash card for remote access and control. The bus control system 164 includes various ports, such as shown, for example, in FIG. 51. The bus control system 164 includes various monitor ports 260, various communication ports 262, a computer input port 264 for connecting the bus control system 164 to a computer 148, a port 266 which connects the bus control system 164 to a XM receiver 152, a net port 268 which connects the bus control system 164 to a network terminal block 160, a power input port 270 which connects the bus control system 164 to a power supply, and other ports such as ports which connect the bus control system 164 to various other components such as, but not limited to, a DVD IR, a satellite television IR, and the like. The communication ports may be connected to any suitable devices. For example, communication port A connects to a first XM receiver 152; communication port B connects to a second XM receiver; communication port C connects to the mixer 154; communication port D connects to a power inverter 600; communication port E connects to a matrix switcher 156; and communication port F connects to a data port 256 of a GPS receiver 150. The power inverter 600 may be any suitable power inverter.

A preferred embodiment of a power inverter 600 is shown, for example, in FIGS. 84 and 85. The power inverter 600 is operatively positioned in an electrical panel of a vehicle. The power inverter 600 receives power from the vehicle and transmits the power to the power strip 158 in the assembly enclosure 104 to power the system. As shown in FIGS. 84 and 85, the power inverter 600 preferably includes a power switch 602, an overload indicator 604, an overload temperature indicator 606, a power saving indicator 608, an over/under voltage protection indicator 610, an AC outlet 612, a battery volts indicator 614, a load watts indicator 616, at least one configuring switch 618, ventilation ports 620, a jack 622, battery terminals 624 and a chassis ground lug 626.

FIGS. 52 and 53 illustrate a preferred embodiment of a matrix switcher 156 of the mobile control system 100. The matrix switcher 156 provides a range of audio and video signal distribution applications where reliable switching is required. The matrix switcher 156 includes various ports for connecting to other components including a power supply port, a SAT TV scaler input port, a DVD scaler input port, a computer/touch panel input port, a touch panel port, a communication port, and various monitor ports.

FIGS. 59 and 60 illustrate a preferred embodiment of a video scaler (SAT TV) 166. The video scaler 166 scales composite video, S-video, component video and optional serial digital interface (SDI) with red, green, blue, horizontal and vertical (RGBHV) pass through. The video scaler 166 includes various ports including a power port which connects to a power supply, a SAT TV input/S-video port, a RGB out port and a composite port. The S-video “in” port connects to a SAT TV receiver video out port. The RGB out port connects to an input port of the matrix switcher 156. The composite port “in” connects to the DVD video out port 354, as shown for example in FIG. 75.

FIGS. 61 and 62 illustrate a preferred embodiment of a video scaler (DVD) 166. The video scaler (DVD) includes various ports such as a power supply port which connects to a power supply, a computer port for receiving DVD TV input, a RGB out port which connects to an input port of the matrix switches and a S-video input port which connects to a SAT TV receiver video out port.

FIG. 63 illustrates a preferred embodiment of a TV satellite receiver 144 of the mobile control system 100. The TV satellite receiver 144 functions to receive signals from the satellite antenna 134 and any other suitable signals. The TV satellite receiver 144 includes various ports such as a power supply port 284 which connects to a power supply, at least one satellite in port 286 which connects to the SAT IDU receiver 146, video ports 304 which connect to the S-video port of the video scaler and a VHF (SAT)/UHF out port 308 which connects to the satellite receiver port 314 of the satellite IDU 146. The TV satellite receiver 144 also includes the following ports: a VCR control port 288, a USB port 290, a printer port 292, a telephone line port 294, a digital audio out port 296, audio ports 302 and a VHF/UHF in port 306, which are open ports available for expansion of the system. At least one of the video ports 304 connects to the mixer 154 and at least one video port 304 connects the TV satellite receiver 144 to the TV satellite scaler 166.

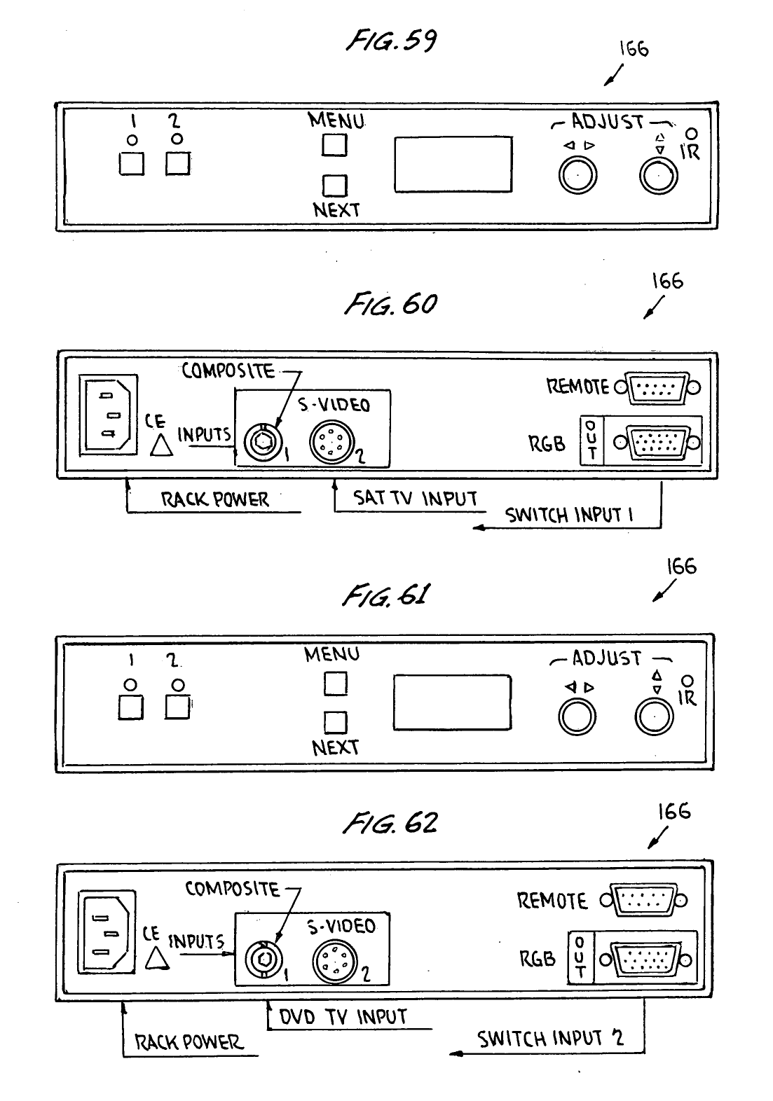

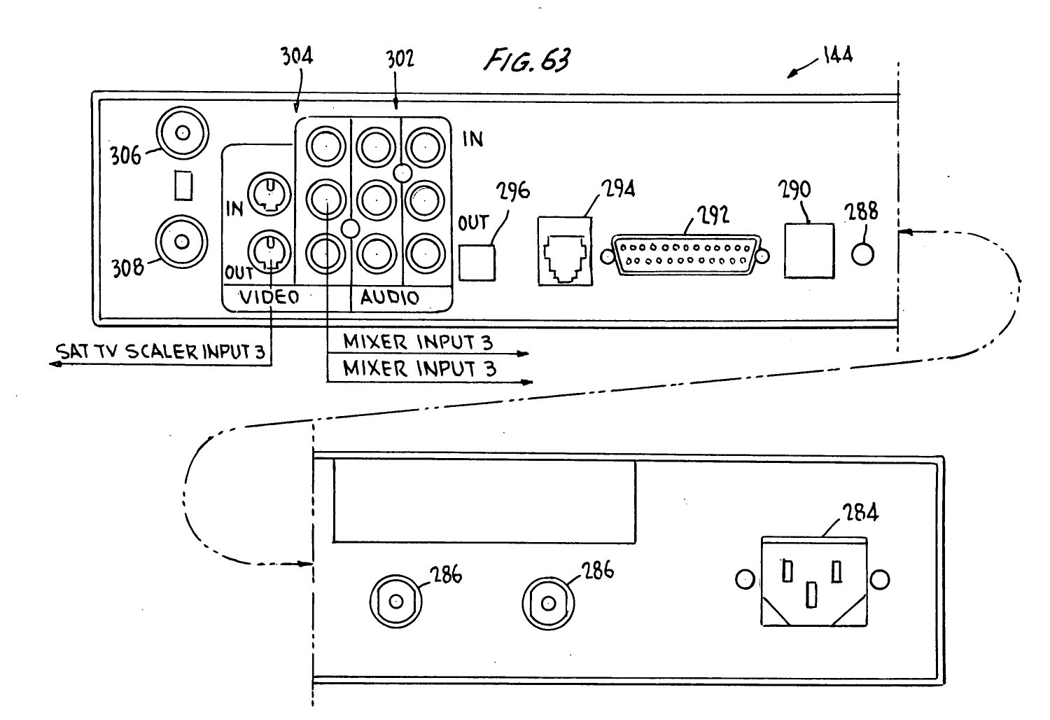

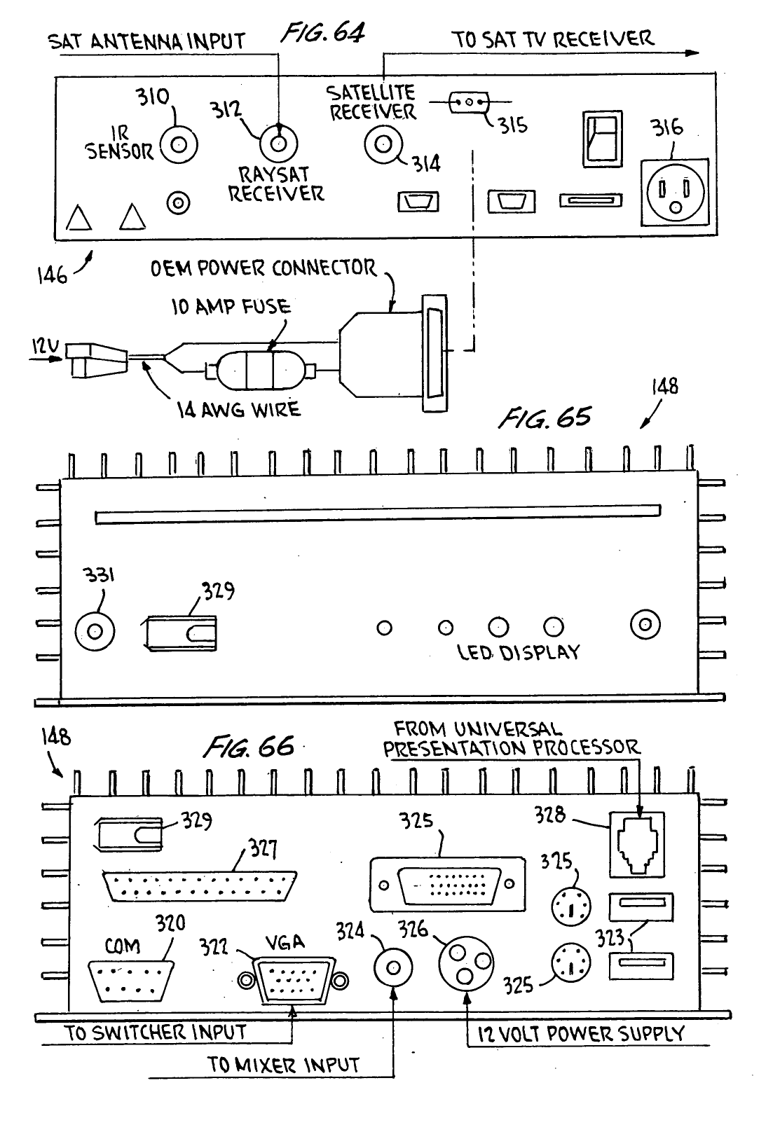

FIG. 64 illustrates a preferred embodiment of a satellite antenna IDU 146. IDU is the set of satellite equipment which is placed inside of a building. The IDU is connected to the outdoor unit (ODU) by an intra facility link (IFL). In consumer satellite television applications, the IDU usually includes a satellite receiver which is connected to a television. In consumer satellite internet applications, the IDU usually consists of a satellite modem which is connected to a computer or a router.

The satellite antenna IDU 146 has various ports including an IR sensor port 310 which is an open port, a satellite receiver port 312 which connects the satellite antenna IDU 146 to the satellite antenna 134, a satellite receiver port 314 which connects the satellite antenna IDU 146 to the TV satellite receiver 144, an OEM power connector port 315 which connects to a vehicle 24 volt power supply via an electrical panel, and a power port 316 which is an open port. The cables which are used in conjunction with the satellite antenna IDU 146 are preferably OEM cables. However, any suitable cables may be used.

FIGS. 65 and 66 illustrate a preferred embodiment of an onboard computer 148. The onboard computer 148 serves as media storage, provides commercial advertising, runs logging programs, and provides possible GPS information. The computer 148 includes various ports including, but not limited to, a communication port 320 which is open, a video graphics array (VGA) port 322 which connects the computer 148 to the switcher 156, a port 324 to connect the computer 148 to the mixer 154, a port 326 to connect the computer 148 to a power supply, and a port 328 to connect the computer 148 to the universal presentation processor 162. The remaining ports are 2 USB ports 323 which are open, and are under port 328, keyboard and music ports 325 which are open and adjacent to the USB ports 323, an HDMI port 325 which is open, a printer port 327 which is open, a fire wire port 329 which is open, and a head phone jack 331 which is open.

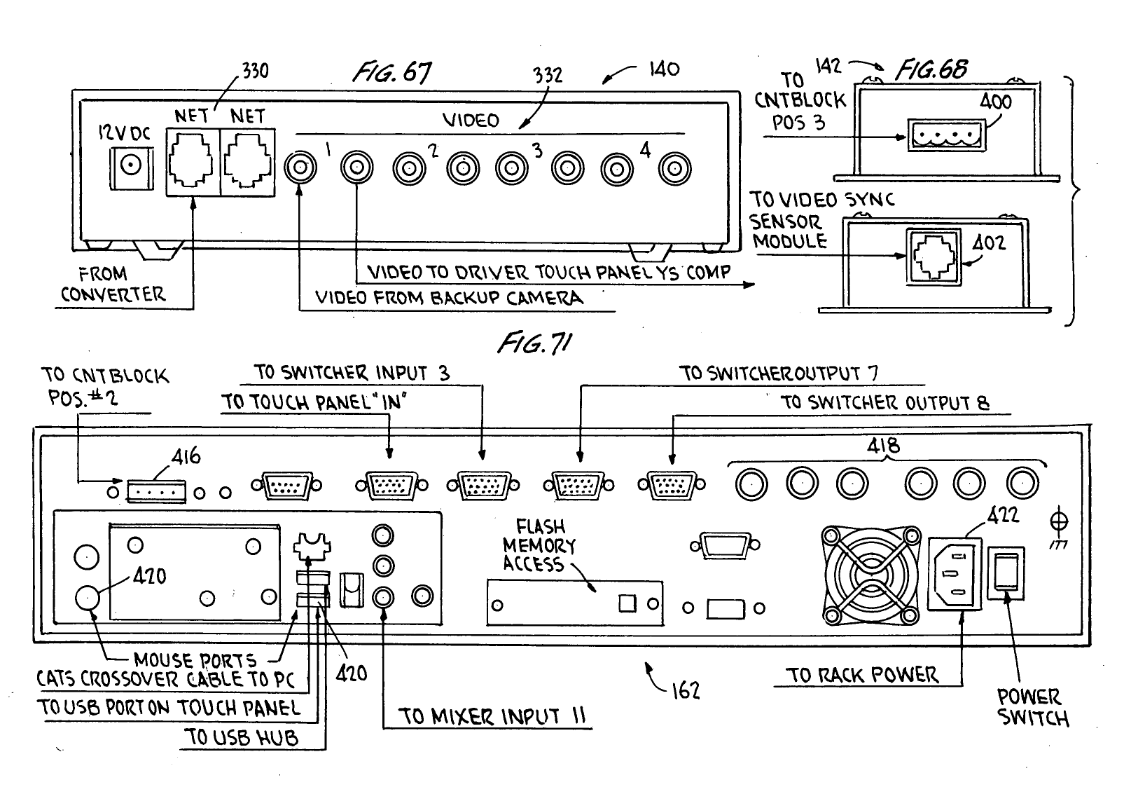

FIG. 67 illustrates a preferred embodiment of a video sync sensor module 140 of the mobile control system 100. The video sync sensor module 140 is used to detect the presence of a video signal coming out of the base band video port (typically a yellow RCA output jack on an audio/visual device) for up to four independent sources. The video sync sensor module 140 includes various ports including at least one net port 330 which connects the video sync sensor module 140 to the converter 142, and video ports 332 which connect the video sync sensor module 140 to video from a backup camera to a touch panel 116 and the like. The backup camera is located outside on the rear of the vehicle (OEM provided). The backup camera assists the driver when the vehicle is in reverse and moving backwards. The image of the camera is then displayed automatically on the driver touch panel when the vehicle is placed in reverse. The touch panel returns to the previous state when the vehicle is placed in “drive” or “park, 1, 2.” In a preferred embodiment, only one port is being used as only one camera is connected. The three other ports are available if the system requires more cameras (2, 3, 4) to be installed. In a preferred embodiment, the camera is a color camera. However, the image can be displayed in black and white as well. The system is fully automated as the driver only needs to glance down at the panel to confirm there is no obstruction behind the vehicle.

FIG. 68 illustrates a partial view of a preferred embodiment of a converter 142 of the mobile control system 100 which includes at least a port 400 which connects the converter 142 to the network terminal block 160 and a port 402 which connects the converter 142 to the net port on the video sync sensor module 140. The converter 142 is a 1-1 converter for 4-wire and network modular cable. The converter provides low voltage power (24 volts) to the sync sensor and programming communication with control unit.

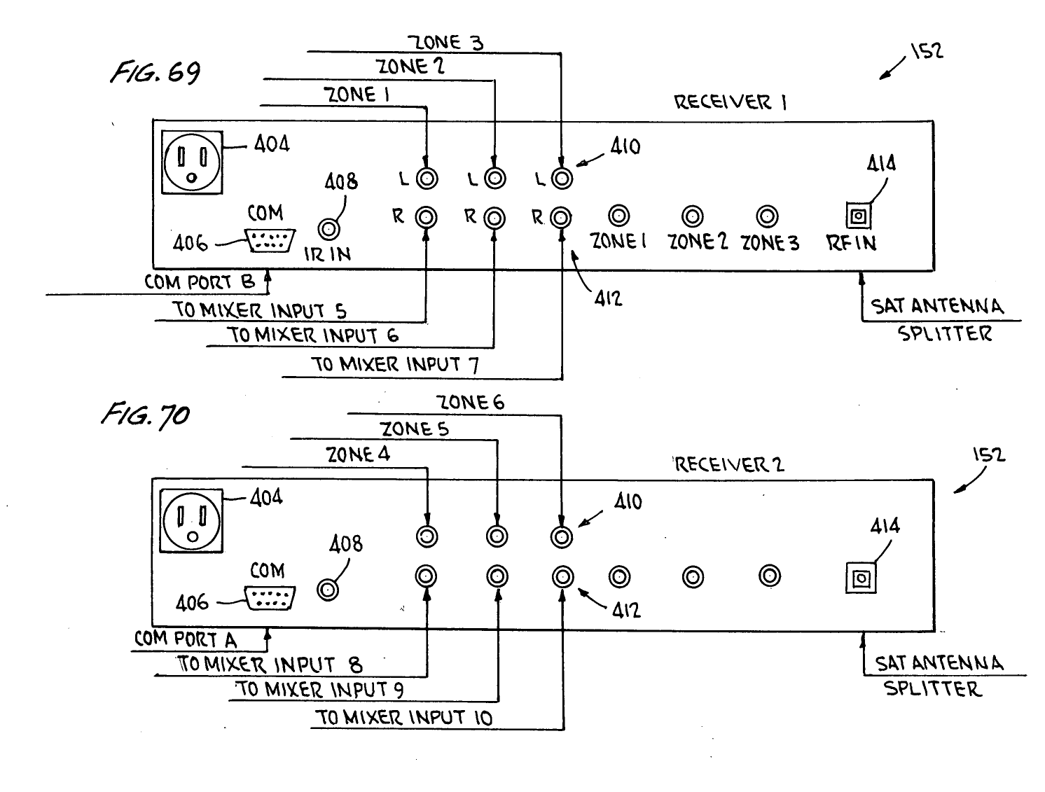

FIG. 69 illustrates a preferred embodiment of a first XM receiver 152 and FIG. 70 illustrates a preferred embodiment of a second XM receiver 152. The XM receiver 152 provides independent channels of satellite radio with all available channels depending on selected “package” or service systems. Both receivers include a power supply port 404 which connects to a power supply, a communication port 406 which connects to communication port A/B 262 of the bus control system 164, an infrared receiver (IR) in port 408 which is open, various ports 410, 412 for receiving transmissions from various zones of the independent receiver in each XM receiver 152, and a radio frequency (RF) in port 414 for receiving transmissions from a satellite antenna splitter. In a preferred embodiment, the zones are connected as follows: Zone 1 audio left and right connects to the mixer at input 5 audio “in”. The mixer transmits this audio to either the cabin speakers or MAS unit 260 or both. Each “zone” or receiver follows the same path. Zone 2 connects to input 6; zone 3 connects to input 7, etc. This allows six independent XM stations to be heard individually through the headset or one channel/station to be heard within the cabin when selected using the touch panels 116. All zones are playing continuously through the MAS unit 260 at the same time. The headset has 8 individual channels to select from, 6 are XM, 1 DVD and 1 SAT TV.

The universal presentation processor 162 provides a stream lined audio/visual and digital media presentation. The universal presentation processor 162 fuses touch panel control with professional annotation, multi-window video processing, and an imbedded multiple media computer. The universal presentation processor 162 supports multiple video and digital media formats, complete with real-time annotation that requires no additional computers, software, or hardware. The universal presentation processor 162 enables a user to have complete display control, providing independently controllable outputs to the user's touch panel and audience display. Multiple scalable video windows and computer applications can be displayed simultaneously for preview while an audience sees only what the user chooses.

The universal presentation processor 162 preferably features, for example, touch panel graphics with a 24 bit color depth and 8 bit alpha channel supporting 16.7 million colors, full motion animations, dynamic text and graphics, animated pop-ups, translucency, and dramatic transition effects with speed. The universal presentation processor 162 preferably delivers a reliable and secure platform for touch panel control with integrated computer functionality that is invulnerable to viruses or other rogue software. In addition to its built-in computer applications, the universal presentation processor 162 supports the display of external video and computer sources in various scalable windows. A built-in seamless video-switcher accepts multiple inputs from national television systems committee/phase alternating line (NTSC/PAL) composite, S-video, component and high definition television (HDTV) sources. Also, the universal presentation processor has two RGB inputs to accommodate two interlaced sources. Individual RGB outputs are provided for the user's touch panel and audience display, allowing the user full control over what the audience sees. The user output displays the control graphical user interface (GUI).

FIG. 71 illustrates a preferred embodiment of a universal presentation processor 162. The universal presentation processor 162 includes various ports such as shown, for example, in FIG. 71. These ports preferably include a net port 416 which connects the universal presentation processor 162 to the network terminal block (CNT block) 160, various video input ports 418, mouse ports 420, and a power supply port 422. More particularly, the universal presentation processor 162 includes ports which connect the universal presentation processor 162 to other components including a touch panel 116, the switcher 156, a USB hub 170, the computer 148, and the mixer 154.

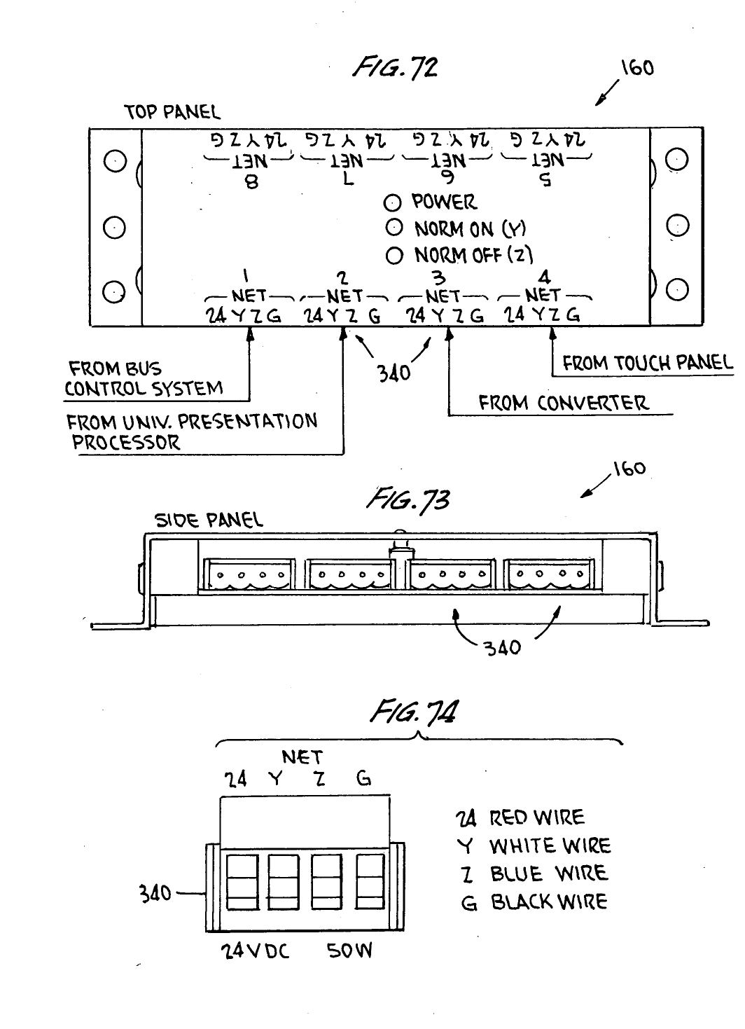

FIGS. 72 and 73 illustrate a preferred embodiment of a network terminal block 160 of the mobile control system 100. The network terminal block (CNT block) 160 is a network terminal expander and diagnostic tool having eight network connectors grouped in two sets of four. Power can be isolated between the two sets by disconnecting a jumper on the board. The unit provides LED indicators which help isolate wiring problems.

In a preferred embodiment, the network terminal block 160 is housed in an enclosure with a silk screened top panel. Three LEDs are preferably located toward the center of the top panel: a green LED (power) and two red LEDs (norm on (Y) and norm off (Z)). Eight four pin network connectors are accessible from the two longest sides of the unit, each side having four connectors per side. The green power LED illuminates when 24 volts is supplied to the network terminal block over the network. If the +24 volt line is improperly connected, the power LED does not illuminate. The red norm on (Y) LED brightly illuminates in combination with an illuminated power LED and a dimly illuminated norm off (Z) LED during normal operating conditions. The red norm off (Z) LED illuminates dimly in combination with a brightly illuminated power and norm on (Y) LED during normal operating conditions. The network connectors are preferably net ports 340 which receive transmissions from other components including the bus control system 164, the universal presentation processor 162, the converter 142, and the touch panels 116. FIG. 74 illustrates a preferred embodiment of a net port 340 of FIGS. 72 and 73.

FIG. 76 illustrates a preferred embodiment of an XM splitter 168 of the mobile control system 100. The XM splitter 168 takes transmissions from the XM antenna 132 and splits the transmission between a first XM receiver 152 and a second XM receiver 152 when the assembly enclosure 104 has two XM receivers, such as shown, for example, in FIG. 5A.

The power strip 158 provides power from an outside source to the mobile control system 100.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

It is claimed:

1. A mobile control system for a vehicle comprising:
at least one cabin based component; and
an assembly enclosure having at least one audio and/or video controlling component,
wherein said mobile control system is constructed and arranged to enable a passenger of said vehicle to control, view and/or listen to at least one predetermined audio and/or visual output either collectively or individually.

2. The mobile control system of claim 1, wherein said at least one cabin based component includes at least one of: a passenger module, a monitor, a speaker, an amplifier, a subwoofer, a global positioning system antenna, a satellite antenna, an extended module antenna, a touch panel, a microphone, a DVD player, a flash card reader, a multichannel audio system unit, an electronic control unit and/or a control processor.

3. The mobile control system of claim 1, wherein said at least one audio and/or video controlling component includes at least one of: a video sync sensor module, a converter, a satellite receiver, a satellite in-door unit, a computer, a global positioning system receiver, an extended module receiver, a mixer, a matrix switcher, a power strip, a network terminal block, a universal presentation processor, a bus control system and/or a scaler.

4. The mobile control system of claim 1, wherein said at least one audio and/or video controlling component of said assembly enclosure is housed in an assembly chassis.

5. The mobile control system of claim 4, wherein said assembly chassis comprises a front cover and a chassis base.

6. The mobile control system of claim 5, wherein said front cover comprises:
a front cover panel with an assembly access cover panel therein;
a top cover panel perpendicular to a top edge of said front cover panel;
a bottom cover panel perpendicular to a bottom edge of said front cover panel;
a first side panel perpendicular to a first side edge of said front cover panel; and
a second side panel perpendicular to a second side edge of said front cover panel.

7. The mobile control system of claim 1, wherein said at least one predetermined audio and/or visual output includes at least one of: a satellite radio channel output, a satellite radio channel output, a satellite television output, a global positioning system output, a DVD output, a flash media output, and/or a driver assistance output.

8. The mobile control system of claim 1, wherein each said at least one cabin based component connects to said assembly enclosure by a connection member.

9. The mobile control system of claim 1, wherein each said at least one cabin based component connects to at least one of said at least one audio and/or video controlling component in said assembly enclosure by a connection member.

10. The mobile control system of claim 8, wherein said connection member is a cable connection.

11. The mobile control system of claim 9, wherein said connection member is a cable connection.

12. The mobile control system of claim 2, wherein said passenger module is operatively positioned in a back of a seat or suspended from a ceiling of said vehicle, wherein said passenger module includes a viewing monitor and/or a touch panel.

13. The mobile control system of claim 2, wherein said touch panel is adapted to enable at least one passenger of said vehicle to control, view and/or listen to said at least one audio and/or visual output.

14. The mobile control system of claim 3, wherein said video sync sensor module is adapted to detect a video from a video port.

15. The mobile control system of claim 3, wherein said bus control system is a network information control system which is adapted to provide input of performance expansion cards; provide throughput of audio and/or visual output throughout said mobile control system; provide secure network communications with plug in internet cards; and/or support at least one internet protocol.

16. The mobile control system of claim 3, wherein said matrix switcher is adapted to provide a range of signal distribution applications.

17. The mobile control system of claim 3, wherein said scaler is a video scaler which is adapted to scale composite video, S-video, component video and/or optional serial digital interface.

18. The mobile control system of claim 3, wherein said network terminal block includes a plurality of net ports which are adapted to receive transmissions from other components including said bus control system, said universal presentation processor, said converter, and/or said touch panel.

19. The mobile control system of claim 3, wherein said satellite in-door unit is adapted to receive and process signals from a satellite antenna.

20. The mobile control system of claim 3, wherein said extended module receiver is adapted to receive transmissions from at least one of said at least one cabin based component or said at least one audio and/or video controlling component.

21. The mobile control system of claim 3, wherein said universal presentation processor is adapted to provide at least one of: (1) a stream lined audio/visual and digital media presentation; (2) touch panel control fused with annotation, multi-window video processing, and an imbedded multiple media computer; (3) support for multiple video and digital media formats, with real-time annotation; (4) display control, providing independently controllable outputs to a touch panel of a user and to an audience display; or (5) multiple scalable video windows and computer applications displayed simultaneously for preview while an audience sees only what a user predetermines.

22. The mobile control system of claim 3, wherein said mixer is adapted to provide audio input, output and/or control within said system.

23. The mobile control system of claim 3, wherein said satellite receiver is adapted to receive signals from a satellite antenna.

24. The mobile control system of claim 3, wherein said computer is adapted to provide media storage, advertising, and GPS formatting.

25. The mobile control system of claim 3, wherein said global positioning system receiver is adapted to receive global positioning system signals from a global positioning system antenna; enable a user to keep track of mobile assets, improve efficiency, and customer service; and/or gain management information.

26. The mobile control system of claim 3, wherein said matrix switcher is adapted to provide a range of signal distribution applications where reliable switching is required.

27. The mobile control system of claim 5, wherein each said at least one audio and/or video controlling component in said assembly enclosure is secured to said chassis base by a mounting plate.
